(19) United States
(12) Patent Application Publication
(10) Pub. No.: US 2020/0044844 A1
(43) Pub. Date: Feb. 6, 2020

(54) AUTHENTICATION OF WIRELESS COMMUNICATIONS

(71) Applicant: QUALCOMM Incorporated, San Diego, CA (US)

(72) Inventors: Srivathsa SRIDHARA, Bhadravathi (IN); Mayank BATRA, Cambridge (GB); Ravi SHEKHAR, Thubarahalli (IN)

(21) Appl. No.: 16/129,595

(22) Filed: Sep. 12, 2018

(30) Foreign Application Priority Data
Aug. 3, 2018 (IN) 201841029307

(51) Int. Cl. H04L 9/14; H04L 9/32; H04L 9/08

(52) U.S. Cl. CPC H04L 9/14; H04L 9/0833; H04L 9/3247; H04L 9/3297

(57) ABSTRACT

This disclosure provides systems, devices, apparatus and methods, including computer programs encoded on storage media, for transmitting wireless communications including obtaining a public and private key pair for a wireless network, transmitting synchronization information to the wireless network, generating a digital signature using the private key based on a nonce and at least a portion of the synchronization information, and transmitting authentication information to the wireless network including the digital signature. This disclosure also provides systems, devices, apparatus and methods, including computer programs encoded on storage media, for receiving wireless communications including verifying the digital signature using the public key, receiving data and reference information based on the synchronization information, and authenticating, based on the verified digital signature and the reference information, the received data.

### PRIORITY INFORMATION

This application claims the benefit of priority under § 35 U.S.C. 119(a) to Indian Patent Application Serial No. 201841029307 (Attorney Docket No. 182021IN1) entitled “Authentication of Wireless Communications” and filed 3 Aug. 2018.

### TECHNICAL FIELD

This disclosure relates generally to wireless communications, and more specifically, to authenticating data transmissions using asymmetric and symmetric encryption techniques.

### DESCRIPTION OF THE RELATED TECHNOLOGY

Data transfer systems may be susceptible to attacks and authentication challenges. A transmitting device may generate and transmit security information to receiving devices to enable the receiving devices to acquire and decrypt subsequent data transmissions. In some configurations, both the transmitting device (the “master”) and a receiving device (the “slave”) contribute to a session key diversifier (SKD) and an initialization vector (IV). For example, the master may generate a master's part of the initialization vector (IVmaster) and a master's part of the session key diversifier (SKDmaster) using a random number generator. The master device then transmits IVmaster and SKDmaster to the slave device. The slave device receives IVmaster and SKDmaster and generates IVslave and SKDslave based on using a random number generator. The slave device then generates a SKD for the session based on a concatenation of SKDmaster and SKDslave. Similarly, the slave generates an IV for the session based on a concatenation of IVmaster and IVslave. The slave device then transmits IVslave and SKDslave to the master device, which the master device then uses to generate the SKD the IV. The master/slave may then utilize an encryption engine to generate a session key (SK) using a long term key (LTK) and the SKD as input.

In some other data transfer system configurations, a broadcaster of data must generate and transmit synchronization information to receiving devices to enable the receiving devices to acquire and decrypt the data. The synchronization information may include a Group Initialization Vector (GIV) and a Group Session Key Diversifier (GSKD). The broadcasting device may also generate a Group Long Term Key (GLTK) that is then distributed to the receiving devices. Each of the broadcasting and receiving devices may generate a Group Session Key (GSK) based on the GLTK and the GSKD. The GLTK and the GSK are generally secure but the GSKD and the GIV are generally not; they are ascertainable by other devices, including would-be attackers, by capturing the packets in which they are transported. A device may abuse the GLTK by pretending to be the genuine transmitting device. The impostor or “spoofing device” may then select its own GIV and GSKD and begin transmitting data to the other receiving devices. Data transfer systems are also susceptible to replay attacks. In some applications, the broadcasting device may use an incrementing payload counter as a nonce for encrypting the data to prevent replay attacks. However, even in instances in which a payload counter is utilized, it is still possible for an attacker to capture the GSKD and the GIV. The attacker may then capture encrypted packets and replay them at a later time giving rise to a replay attack. The attack is made possible because the broadcasting device is solely responsible for computing or otherwise determining the GSKD and the GIV; that is, the broadcasting device does not use input from the receiving devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication by a transmitting device. In some implementations, the method includes obtaining a public and private key pair for wireless communications with a wireless network that includes at least one receiving device. The method also includes transmitting synchronization information for the wireless communications to the wireless network. The method additionally includes generating a digital signature using the private key based on a nonce and at least a portion of the synchronization information. The method further includes transmitting authentication information to the wireless network, the authentication information including the digital signature.

Another innovative aspect of the subject matter described in this disclosure can be implemented in a wireless communication device. In some implementations, the wireless communication device includes at least one processor and at least one memory communicatively coupled with the at least one processor. The memory stores processor-readable code that, when executed by the at least one processor, causes the wireless communication device to obtain a public and private key pair for wireless communications with a wireless network that includes at least one receiving device. The code is also configured to, when executed by the at least one processor, cause the wireless communication device to transmit synchronization information for the wireless communications to the wireless network. The code is additionally configured to, when executed by the at least one processor, cause the wireless communication device to generate a digital signature using the private key based on a nonce and at least a portion of the synchronization information. The code is further configured to, when executed by the at least one processor, cause the wireless communication device to transmit authentication information to the wireless network, the authentication information including the digital signature.

Another innovative aspect of the subject matter described in this disclosure can be implemented in a tangible computer-readable storage medium comprising non-transitory processor-executable code operable to obtain a public and private key pair for wireless communications with a wireless network that includes at least one receiving device. The code is also operable to transmit synchronization information for the wireless communications to the wireless network. The code is additionally operable to generate a digital signature using the private key based on a nonce and at least a portion of the synchronization information. The code is further operable to transmit authentication information to the wireless network, the authentication information including the digital signature.

In some implementations of the methods, wireless communication devices and computer-readable storage media, the wireless communications are broadcast isochronous communications. In some such implementations, the methods, wireless communication devices and computer-readable storage media may be configured to generate an encryption key for the broadcast isochronous communications, encrypt isochronous data using the encryption key, and broadcast the encrypted isochronous data to the wireless network in at least one isochronous data packet.

In some such implementations, the methods, wireless communication devices and computer-readable storage media may be configured to encrypt the authentication information using the encryption key prior to transmission. In some implementations of the methods, wireless communication devices and computer-readable storage media, generating the encryption key includes generating a Group Long Term Key (GLTK); generating a Group Session Key Diversifier (GSKD); and generating a Group Session Key (GSK) based on the GLTK and the GSKD.

In some such implementations, the methods, wireless communication devices and computer-readable storage media may be configured to generate a Group Initialization Vector (GIV), where the synchronization information includes the GSKD and the GIV. In some implementations of the methods, wireless communication devices and computer-readable storage media, generating the digital signature includes executing a digital signature algorithm that certifies the nonce and a combination of the GSKD and the GIV using the private key. In some implementations, the nonce includes a timestamp or a counter.

In some implementations of the methods, wireless communication devices and computer-readable storage media, transmitting the synchronization information to the wireless network includes broadcasting the synchronization information in at least one first advertising packet. In some implementations, transmitting the authentication information to the wireless network also includes broadcasting the authentication information in the at least one first advertising packet.

Another innovative aspect of the subject matter described in this disclosure can be implemented in a method for wireless communication by a receiving device. In some implementations, the method includes obtaining a public key for wireless communications. The method also includes receiving, from a transmitting device, synchronization information for the wireless communications. The method also includes receiving, from the transmitting device, authentication information for the wireless communications, the authentication information including a digital signature of the transmitting device, the digital signature being based on a nonce and a combination of at least a portion of the synchronization information. The method also includes verifying the digital signature using the public key. The method additionally includes receiving, based on at least a portion the synchronization information, at least one data packet including data and reference information. The method further includes authenticating, based on the verified digital signature and the reference information, the received data.

Another innovative aspect of the subject matter described in this disclosure can be implemented in a wireless communication device. In some implementations, the wireless communication device includes at least one processor and at least one memory communicatively coupled with the at least one processor. The memory stores processor-readable code that, when executed by the at least one processor, causes the wireless communication device to obtain a public key for wireless communications. The code is also configured to, when executed by the at least one processor, cause the wireless communication device to receive, from a transmitting device, synchronization information for the wireless communications. The code is also configured to, when executed by the at least one processor, cause the wireless communication device to receive, from the transmitting device, authentication information for the wireless communications, the authentication information including a digital signature of the transmitting device, the digital signature being based on a nonce and a combination of at least a portion of the synchronization information. The code is also configured to, when executed by the at least one processor, cause the wireless communication device to verify the digital signature using the public key. The code is additionally configured to, when executed by the at least one processor, cause the wireless communication device to receive, based on at least a portion the synchronization information, at least one data packet including data and reference information. The code is further configured to, when executed by the at least one processor, cause the wireless communication device to authenticate, based on the verified digital signature and the reference information, the received data.

Another innovative aspect of the subject matter described in this disclosure can be implemented in a tangible computer-readable storage medium comprising non-transitory processor-executable code operable to obtaining a public key for wireless communications. The code is also operable to receive, from a transmitting device, synchronization information for the wireless communications. The code is also operable to receive, from the transmitting device, authentication information for the wireless communications, the authentication information including a digital signature of the transmitting device, the digital signature being based on a nonce and a combination of at least a portion of the synchronization information. The code is also operable to verify the digital signature using the public key. The code is additionally operable to receive, based on at least a portion the synchronization information, at least one data packet including data and reference information. The code is further operable to authenticate, based on the verified digital signature and the reference information, the received data.

In some implementations of the methods, wireless communication devices and computer-readable storage media, the wireless communications are broadcast isochronous communications. In some such implementations, the received isochronous data is encrypted. In such implementations, the methods, wireless communication devices and computer-readable storage media may be configured to generate an encryption key for the wireless communications and decrypt the received isochronous data using the encryption key. In some implementations, the received authentication information also is encrypted, in which case the received authentication information may be decrypted using the encryption key.

In some implementations, the synchronization information includes a Group Session Key Diversifier (GSKD). In some such implementations, the methods, wireless communication devices and computer-readable storage media may be configured to obtain a Group Long Term Key (GLTK) and generate the encryption key based on the GLTK and the GSKD.

In some implementations, the synchronization information further includes a Group Initialization Vector (GIV). In some such implementations, the combination of the synchronization information includes the GSKD and the GIV. In some implementations of the methods, wireless communication devices and computer-readable storage media, verifying the digital signature includes executing a digital signature algorithm that, using the public key, indicates that the nonce and the combination of the synchronization information have been certified by the transmitting device using a private key of the transmitting device. In some such implementations, the reference information includes timing information and authenticating the received data includes identifying timing information in the nonce, comparing the timing information in the reference information with the timing information identified in the nonce, and authenticating the received data based on the comparison. In some such implementations, the timing information in the nonce includes a timestamp or a counter.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a block diagram of an example wireless access point (AP) for use in wireless communication.

FIG. 3 shows a block diagram of an example wireless station (STA) for use in wireless communication.

FIG. 4 shows a pictorial diagram of another example wireless communication network.

FIG. 5 shows a timing diagram illustrating a broadcast isochronous channel and a plurality of advertising channels capable of use by a station (STA) of the wireless communication network of FIG. 4.

FIG. 6 shows a block diagram of an example STA capable of use in the wireless communication network of FIG. 4.

FIG. 7 shows a flowchart illustrating an example process for wireless communication by a transmitting device according to some implementations.

FIG. 8 shows a flowchart illustrating an example process for wireless communication by a broadcasting device according to some implementations.

FIG. 9 shows a flowchart illustrating an example process for wireless communication by a receiving device according to some implementations.

FIG. 10 shows a flowchart illustrating an example process for wireless communication by a scanning device according to some implementations.

FIG. 11 shows a block diagram of an example wireless communication device for use in wireless communication according to some implementations.

FIG. 12 shows a block diagram of an example wireless communication device for use in wireless communication according to some implementations.

FIG. 13 shows a timing diagram illustrating a broadcast isochronous channel and a plurality of advertising channels capable of use by a wireless communication device.

FIG. 14 shows an example protocol data unit (PDU) usable for conveying authentication information according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to wireless communications, and more specifically, to authenticating data transmissions using asymmetric and symmetric encryption techniques. Some implementations more specifically relate to authentication techniques for authenticating broadcast isochronous data streams. The authentication techniques include the generation and verification of a digital signature. The broadcasting device generates and broadcasts synchronization information enabling receiving devices to acquire the broadcast isochronous data. In some implementations, the broadcasting device generates the digital signature by certifying a combination of a nonce and the synchronization information using a private key. In some implementations, a receiving device receives the digital signature, verifies it to ensure the integrity of the certified nonce and synchronization information, and uses the certified information to authenticate subsequently received broadcast isochronous data.

In some implementations or respects, the authentication operations can be divided into asymmetric and symmetric operations. For example, the disclosed authentication techniques can utilize both an asymmetric encryption procedure as well as a symmetric encryption procedure. For example, the asymmetric encryption operations can include, on the transmitter side, the generation of authentication data including a digital signature and, on the receiver side, the verification of the digital signature. The symmetric encryption operations can include, on the transmitter side, the generation of an encryption key (a session key) and the encryption of both the authentication information and the subsequent data using the encryption key. Similarly, the symmetric encryption can include, on the receiver side, the generation of an encryption key and the decryption of the authentication information and the subsequent data using the encryption key.

Particular implementations of the subject matter described in this disclosure can be implemented to realize one or more of the following potential advantages. In some implementations, the described techniques can be used to authenticate wireless communications including broadcast isochronous data transmissions. For example, the described authentication techniques can be used to prevent the abuse of a LTK as well as to prevent replay attacks. Additionally, various implementations provide scalability to a virtually unlimited number of receiving devices because the authentication does not rely on an exchange of authentication requests and authentication responses as is typical in conventional authentication techniques.

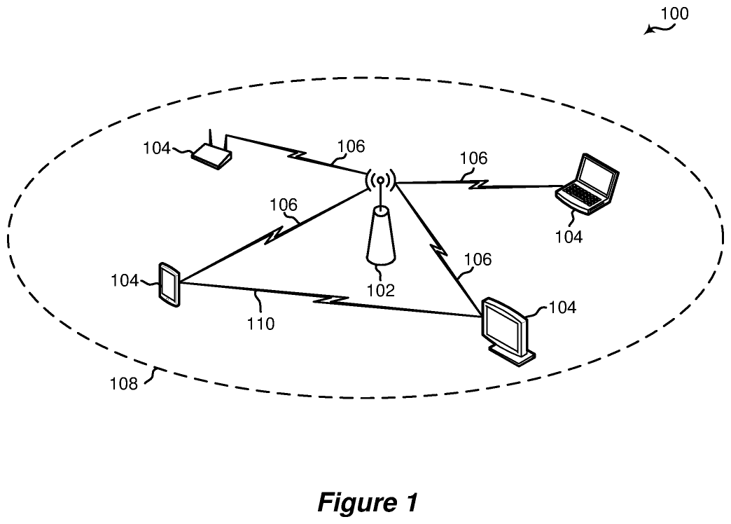

FIG. 1 shows a pictorial diagram of an example wireless communication network 100. In various implementations, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an access point (AP) 102 and multiple stations (STAs) 104. Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, copiers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP. The BSS is identified by a service set identifier (SSID) that is advertised by the AP 102. The AP 102 periodically broadcasts beacon frames (“beacons”) to enable any STAs 104 within wireless range of the AP 102 to establish and/or maintain a respective communication link 106 (hereinafter also referred to as a “Wi-Fi link”) with the AP. The various STAs 104 in the WLAN are able to communicate with external networks as well as with one another via the AP 102 and respective communication links 106. To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a Wi-Fi link with the selected AP.

FIG. 1 additionally shows an example coverage area 108 of the AP 102, which may represent a basic service area (BSA) of the WLAN 100. While only one AP 102 is shown, the WLAN network 100 can include multiple APs 102. As a result of the increasing ubiquity of wireless networks, a STA 104 may have the opportunity to select one of many BSSs within range of the STA and/or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP with which to associate. For example, a STA 104 that is moving relative to its associated AP 102 may perform a “roaming” scan to find another AP having more desirable network characteristics such as a greater received signal strength indicator (RSSI).

The APs 102 and STAs 104 may function and communicate (via the respective communication links 106) according to the IEEE 802.11 family of standards (such as that defined by the IEEE 802.11-2016 specification or amendments thereof including, but not limited to, 802.11ah, 802.11ay, 802.11ax, 802.11az, and 802.11ba). These standards define the WLAN radio and baseband protocols for the PHY and medium access control (MAC) layers. The APs 102 and STAs 104 transmit and receive frames (hereinafter also referred to as “Wi-Fi communications”) to and from one another in the form of physical layer convergence protocol (PLCP) protocol data units (PPDUs). Each PPDU is a composite frame that includes a PLCP preamble and header as well as one or more MAC protocol data units (MPDUs).

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac and 802.11ax standard amendments may be transmitted over physical channels having bandwidths of 40 MHz, 80 MHz or 160 MHz by bonding together two or more 20 MHz channels. Additionally, in some implementations the AP 102 can transmit PPDUs to multiple STAs 104 simultaneously using one or both of multi user (MU) multiple-input multiple-output (MIMO) (also known as spatial multiplexing) and orthogonal frequency division multiple access (OFDMA) schemes.

Each PPDU typically includes a PLCP preamble, a PLCP header and a MAC header prior to the accompanying data. The information provided in the preamble and headers may be used by a receiving device to decode the subsequent data. A legacy portion of the preamble may include a legacy short training field (STF) (L-STF), a legacy LTF (L-LTF), and a legacy signaling field (L-SIG). The legacy preamble may be used for packet detection, automatic gain control and channel estimation, among other uses. The legacy preamble may also be used to maintain compatibility with legacy devices. In instances in which PPDUs are transmitted over a bonded channel, the L-STF, L-LTF, and L-SIG fields may be duplicated and transmitted in each of the plurality of component channels. For example, in IEEE 802.11n, 802.11ac or 802.11ax implementations, the L-STF, L-LTF, and L-SIG fields may be duplicated and transmitted in each of the component 20 MHz channels. The format of, coding of, and information provided in the non-legacy portion of the preamble is based on the particular IEEE 802.11 protocol.

The AP 102, as well as some capable STAs 104, may support beamforming. For example, the AP 102 may use multiple antennas or antenna arrays to conduct beamforming operations for directional communications with a STA 104, and vice versa. Beamforming (which may also be referred to as spatial filtering or directional transmission) is a signal processing technique that may be used at a transmitter (for example, AP 102) to shape and/or steer an overall antenna transmission beam in the direction of a target receiver (for example, a STA 104). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 102 may communicate with the STA 104. That is, based on this CSI, the AP 102 may appropriately weight the transmissions from each antenna (for example or antenna port) such that the desired beamforming effects are achieved. In some cases, these weights may be determined before beamforming can be employed. For example, the transmitter (the AP 102) may transmit one or more sounding packets (for example, a null data packet) to the receiver in order to determine CSI.

In some cases, aspects of transmissions may vary based on a distance between a transmitter (for example, AP 102) and a receiver (for example, STA 104). WLAN 100 may otherwise generally benefit from AP 102 having information regarding the location of the various STAs 104 within coverage area 108. In some examples, relevant distances may be computed using RTT-based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs).

Some types of STAs 104 may support automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 104 that integrate sensors or meters to measure or capture information and relay that information to a central server or application program that can make use of the information, enable automated behavior of machines, or present the information to humans interacting with the program or application. Examples of applications for such devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

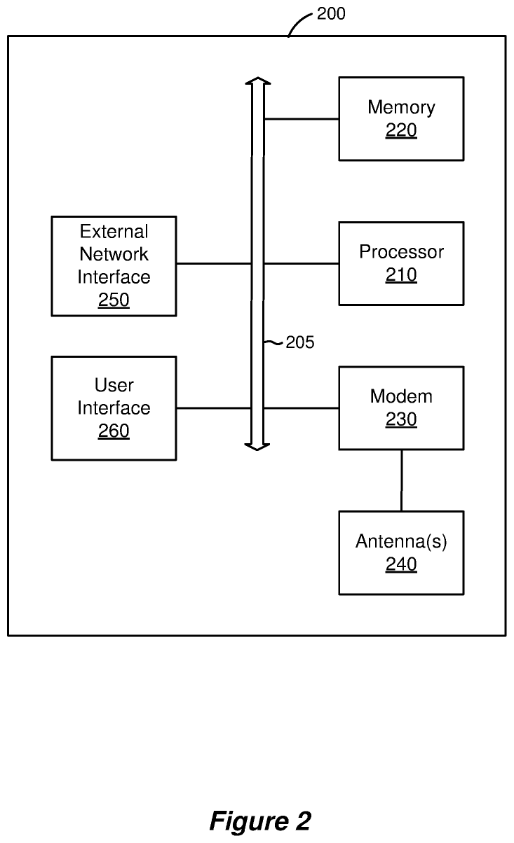

FIG. 2 shows a block diagram of an example access point (AP) 200 for use in wireless communication. For example, the AP 200 may be an example implementation of the AP 102 described with reference to FIG. 1. The AP 200 is capable of transmitting and receiving wireless communications (for example, in the form of wireless packets), as well as of encoding and decoding such communications. For example, the wireless communications can include Wi-Fi packets including frames conforming to an IEEE 802.11 standard (such as that defined by the IEEE 802.11-2016 specification or amendments thereof including, but not limited to, 802.11ah, 802.1l ay, 802.11ax, 802.11az, and 802.11ba). The AP 200 includes at least one processor 210 (collectively “the processor 210”), at least one memory 220 (collectively “the memory 220”), at least one modem 230 (collectively “the modem 230”), at least one antenna 240 (collectively “the antenna 240”), at least one external network interface 250 (collectively “the network interface 250”) and, in some instances, a user interface (UI) 260. Each of the components (or “modules”) described with reference to FIG. 2 can communicate with other ones of the components, directly or indirectly, over at least one bus 205.

The processor 210 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 210 processes information received through the modem 230 and the external network interface 330. The processor 210 also can process information to be sent to the modem 230 for transmission through the antenna 240 and information to be sent to the external network interface 250. The processor 210 can generally be configured to perform various operations related to generating and transmitting downlink (DL) frames and receiving uplink (UL) frames.

The memory 220 can include random access memory (RAM) and read-only memory (ROM). The memory 220 also can store processor- or computer-executable software (SW) code containing instructions that, when executed by the processor 210, cause the processor to perform various functions described herein for wireless communication, including generation and transmission of a DL frame and reception of an UL frame.

The modem 230 is generally configured to modulate packets and to provide the modulated packets to the antenna 240 for transmission, as well as to demodulate packets received from the antenna 240 to provide demodulated packets. The modem 230 generally includes or is coupled with at least one radio frequency (RF) transmitter and at least one RF receiver, which may be combined into one or more transceivers, and which are in turn coupled to one or more respective antennas 240. For example, in some AP implementations, the AP 200 can include multiple transmit antennas (each with a corresponding transmit chain) and multiple receive antennas (each with a corresponding receive chain). The modem 230 can communicate bi-directionally, via the antenna 240, with at least one STA (such as the STA 104 described with reference to FIG. 1).

The modem 230 may include digital signal processing (DSP) circuitry, an automatic gain control (AGC), a demodulator, a decoder and a demultiplexer. The digital signals received from the transceivers are provided to the DSP circuitry. The DSP circuitry is configured to acquire a received signal from the digital signals, for example, by detecting the presence of the signal and estimating the initial timing and frequency offsets. The DSP circuitry is further configured to digitally condition the digital signals, for example, by performing channel (narrowband) filtering, performing analog impairment conditioning (such as correcting for I/Q imbalance), and by applying digital gain to ultimately obtain a narrowband signal. The output of the DSP circuitry is fed to the AGC, which is configured to use information extracted from the digital signals, for example, in one or more received training fields, to determine an appropriate gain. The output of the DSP circuitry also is coupled with the demodulator, which is configured to extract modulated symbols from the narrowband signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 210 for processing, evaluation or interpretation, for example, by one or more host applications executing on the processor.

The AP 200 may communicate with a core or backhaul network through the external network interface 250 to gain access to external networks including the Internet. For example, the external network interface 250 may include one or both of a wired network interface (for example, an Ethernet interface) or a wireless wide area network (WWAN) interface (for example, including a cellular interface such as an LTE, 4G or 5G interface).

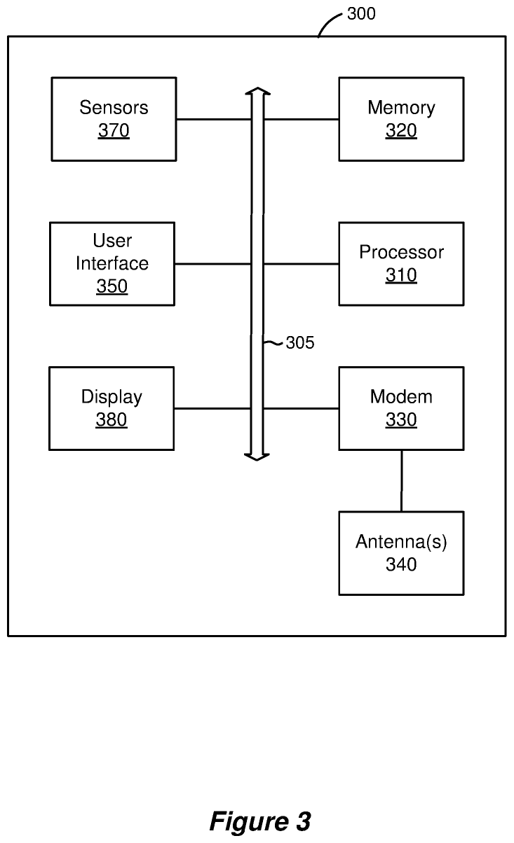

FIG. 3 shows a block diagram of an example wireless station (STA) 300 for use in wireless communication. For example, the STA 300 may be an example implementation of the STA 104 described with reference to FIG. 1. The STA 300 is capable of transmitting and receiving wireless communications, as well as of encoding and decoding such communications. The wireless communications may conform to any of a number of different wireless communication protocols. For example, the STA 300 may be capable of transmitting and receiving Wi-Fi packets including frames conforming to an IEEE 802.11 standard, such as defined by the IEEE 802.11-2016 specification or amendments thereof including, but not limited to, 802.11ah, 802.1l ay, 802.11ax, 802.11az, and 802.11ba). Additionally or alternatively, the STA 300 may be capable of transmitting and receiving Bluetooth packets conforming to a Bluetooth standard, such as defined in IEEE 802.15 or by the Bluetooth SIG. Additionally or alternatively, the STA 300 may be capable of transmitting and receiving wireless packets associated with the Long Term Evolution (LTE), International Mobile Telecommunications-Advanced (IMT-Advanced) 4G or 5G standards.

The STA 300 includes at least one processor 310 (collectively “the processor 310”), at least one memory 320 (collectively “the memory 320”), at least one modem 330 (collectively “the modem 330”) and at least one antenna 340 (collectively “the antenna 340”). In some implementations, the STA 300 additionally includes some or all of the following: a user interface (UI) 350 (such as a touchscreen or keypad), one or more sensors 370 (such as one or more inertial sensors, accelerometers, temperature sensors, pressure sensors, or altitude sensors), and a display 380. Each of the components (or “modules”) described with reference to FIG. 3 can communicate with one another, directly or indirectly, over at least one bus 305.

The processor 310 includes an intelligent hardware device such as, for example, a CPU, a microcontroller, an ASIC or a PLD such as an FPGA, among other possibilities. The processor 310 processes information received through the modem 330 as well as information to be sent to the modem 330 for transmission through the antenna 340. The processor 310 can be configured to perform various operations related to receiving a downlink frame and generating and transmitting an uplink frame.

The memory 320 can include RAM and ROM. The memory 320 also can store processor- or computer-executable SW code containing instructions that, when executed, cause the processor 310 to perform various functions described herein for wireless communication, including reception of a downlink frame and generation and transmission of an uplink frame.

The modem 330 is generally configured to modulate packets and provide the modulated packets to the antenna 340 for transmission, as well as to demodulate packets received from the antenna 340 to provide demodulated packets. The modem 330 generally includes at least one radio frequency (RF) transmitter and at least one RF receiver, which may be combined into one or more transceivers, and which are in turn coupled to one or more respective antennas 340. For example, in some implementations, the STA 300 can include multiple transmit antennas (each with a corresponding transmit chain) and multiple receive antennas (each with a corresponding receive chain). The modem 330 can communicate bi-directionally, via the antenna 340, with at least one AP (such as the AP 102 or AP 200 described with reference to FIGS. 1 and 2, respectively). As is described above, in some implementations, the modem also can communicate bi-directionally, via the antenna 340, with other STAs directly without the use of an intermediary AP.

The modem 330 may include DSP circuitry, an AGC, a demodulator, a decoder and a demultiplexer. The digital signals received from the transceivers are provided to DSP circuitry configured to acquire a received signal from the digital signals, for example, by detecting the presence of the signal and estimating the initial timing and frequency offsets. The DSP circuitry is further configured to digitally condition the digital signals, for example, by performing channel (narrowband) filtering, performing analog impairment conditioning (such as correcting for I/Q imbalance), and by applying digital gain to ultimately obtain a narrowband signal. The output of the DSP circuitry is fed to the AGC, which is configured to use information extracted from the digital signals, for example, in one or more received training fields, to determine an appropriate gain. The output of the DSP circuitry also is coupled with the demodulator, which is configured to extract modulated symbols from the narrowband signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 310 for processing, evaluation or interpretation, for example, by one or more host applications executing on the processor.

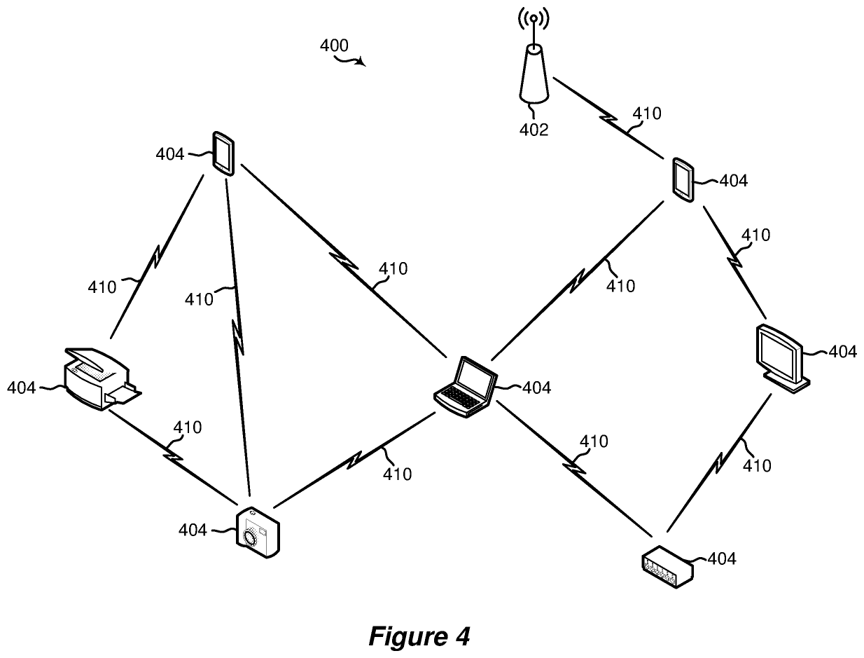

FIG. 4 shows a pictorial diagram of another example wireless communication network 400. In various implementations, the wireless communication network 400 can be an example of a wireless local area network (WLAN) or a wireless personal area network (PAN). The wireless communication network (hereinafter “wireless network”) 400 may include multiple wireless communication devices including STAs 404. For example, some STAs 404 may be implementations of the STAs 104 or 300 described with reference to FIGS. 1 and 3, respectively. Each of the STAs 404 also may be referred to as a mobile station (MS), a mobile device, a mobile handset, a wireless handset, an access terminal (AT), a user equipment (UE), a subscriber station (SS), or a subscriber unit, among other possibilities. The STAs 204 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, copiers, kitchen or other household appliances, key fobs (for example, for passive keyless entry and start (PKES) systems), among other possibilities.

The wireless network 400 is an example of an ad hoc network. The STAs 404 can communicate directly with one another via wireless links 410. In some implementations, the WLAN 400 is an example of a Bluetooth network and the STAs 404 are Bluetooth-compliant devices. A Bluetooth device can be any device, such as a Bluetooth-compliant STA 404, that implements one or more of the Bluetooth wireless communication protocols as defined by the IEEE 802.15 or Bluetooth Special Interest Group (SIG) standards, for example, including the Bluetooth 4.0 Specification and the Bluetooth 5.0 Specification. Bluetooth refers to a set of short-range wireless communication protocols including the Basic Rate (BR) core configuration, including the Enhanced Data Rate (EDR) configuration, and the Low Energy (LE) core configuration as, for example, defined in Bluetooth SIG Specification Versions 4.0 and 5.0. Both the BR physical (PHY) layer and the LE PHY layer operate in the unlicensed Industrial, Scientific and Medical (ISM) 2.4 GHz short-range radio frequency band (2400-2483.5 MHz) and may utilize frequency-hopping spread spectrum radio technology and shaped, binary frequency modulation.

Bluetooth-compliant STAs 404 (hereinafter “STAs 404”) may transmit and receive Bluetooth communications (for example, in the form of Bluetooth packets) to and from one another over wireless links 410 (hereinafter also referred to as “Bluetooth links”) according to a master/slave architecture. Additionally or alternatively, STAs 404 may transmit and receive Bluetooth packets according to a broadcaster/scanner architecture (as described further below). In the master/slave architecture, one of the STAs 404, referred to as the master, provides clock synchronization to the other STAs 404, which are referred to as slaves. During typical operation, a physical radio channel can be shared by multiple STAs 404 (referred to as a “piconet”). The STAs 404 of a Bluetooth piconet are synchronized to the common clock and frequency (channel) hopping pattern specified by the master. A master STA 404 may have PHY links with multiple slave STAs 404 simultaneously. Similarly, a slave STA 404 may be permitted to have PHY links to more than one master STA 404 at a time. Additionally, a STA 204 may be permitted to have the role of both master and slave at the same time; for example, a STA 404 may be a master as it pertains to a first PHY link with another Bluetooth device while simultaneously being a slave as it pertains to a second PHY link with yet another Bluetooth device.

According to the Bluetooth Specification, packets are communicated via a logical link control and adaptation protocol (L2CAP) channel, which is layered over logical links and logical transports, which are in turn built on physical links, physical channels and physical transports. The BR logical transports include the Synchronous Connection-Oriented (SCO), extended SCO (eSCO), Asynchronous Connection-Less (ACL), Active Slave Broadcast (ASB) and Connectionless Slave Broadcast (CSB) logical transports. Both the synchronous and the asynchronous logical transports may represent point-to-point links between a master STA 404 and a respective slave STA 404. The master STA 404 maintains the synchronous logical transports using reserved time slots at regular intervals to transmit SCO and eSCO packets. The master STA 404 can establish an ACL logic transport on a per-slot basis to transmit ACL packets to any slave STA 404 in the time slots not reserved for SCO and eSCO packets.

The BR PHY supports a BR mode having a bit rate of 1 Mbps, and an EDR mode having a bit rate of 2 or 3 Mbps. Each BR packet (for example, in the form of a protocol data unit (PDU)) generally includes three portions: an access code, a header and a payload (which may have zero length). The access code includes a preamble used for DC offset compensation, a sync word used for timing acquisition and synchronization, and optionally a trailer. The access code is also used for identification purposes; all packets transmitted in a single physical channel share the same access code. The packet header includes the link control information including a logical transport address and a packet type identification. In master-to-slave transmissions, the logical transport address indicates the destination slave STA 404 (or multiple slaves in the case of broadcast transmissions) by which the packet is intended to be received, while in slave-to-master transmissions, the logical transport address indicates the source STA 404 transmitting the packet.

The Bluetooth LE core configuration is particularly designed to enable STAs 404 having relatively lower current consumption, complexity and cost than BR- or EDR-supporting STAs 404. For example, LE may be especially advantageous for use cases and applications requiring lower data rates and duty cycles. LE STAs 404 may support three PHY modes (“PHYs”): LE 1M, LE 2M and LE Coded, supporting bit rates of 1 megabit per second (Mbps), 2 Mbps, and either 125 kilobits per second (kpbs) or 500 kpbs (depending on the coding), respectively. LE supports both frequency division multiple access (FDMA) and time division multiple access (TDMA) schemes. Forty physical channels separated by 2 MHz may be used in the FDMA scheme. For TDMA, a polling scheme is used in which one device transmits at a predetermined time and a corresponding device responds after a predetermined time interval. The LE logical transports include the LE asynchronous connection (LE ACL), LE Advertising Broadcast (ADVB) and LE Periodic Advertising Broadcast (PADVB) logical transports. Each LE packet (PDU) generally includes a preamble, an access address (including an access code), a PDU header and a PDU payload. LE packets may also include a message integrity check (MIC) and a cyclic redundancy check (CRC) following the payload.

In the LE core configuration, several physical channels are defined including advertising, periodic, data and isochronous channels. The physical channels are divided into time units called events during which STAs 404 may communicate with one another. These events may in turn be sub-divided into sub-events (also referred to herein simply as “events”). For example, such events may include advertising events, connection events and isochronous events. STAs 404 transmit particular types of packets associated with particular types of events on particular physical channels. For example, each connection event is initiated by a master STA 404 via a connection creation procedure. Frequency channel hopping can occur at the start of each connection event. Connection events may be used to transmit asynchronous data PDUs (“data packets”) between STAs 404 via data channels.

Advertising events may be used for unidirectional or broadcast communications between STAs 404. For example, advertising events may be used to transmit advertising channel PDUs (“advertising packets”) via one or more advertising channels to establish pair-wise bidirectional communications via data channels, periodic broadcasts via secondary advertising channels, or isochronous broadcasts via isochronous channels. For example, if an advertising device (“advertiser”) is using a connectable advertising event, the initiating device (“initiator”) may make a connection request using the same advertising PHY channel on which it received the advertising packet. If the advertiser receives and accepts the connection request, a connection is established and the initiator becomes the master device while the advertiser becomes a slave device. For example, ADV_EXT_IND and ADV_AUX_IND PDUs (“packets”) may be transmitted during extended advertising events for scanning purposes or to initiate other devices, while AUX_SYNC_IND PDUs (“packets”) may be transmitted during periodic advertising events also for scanning purposes.

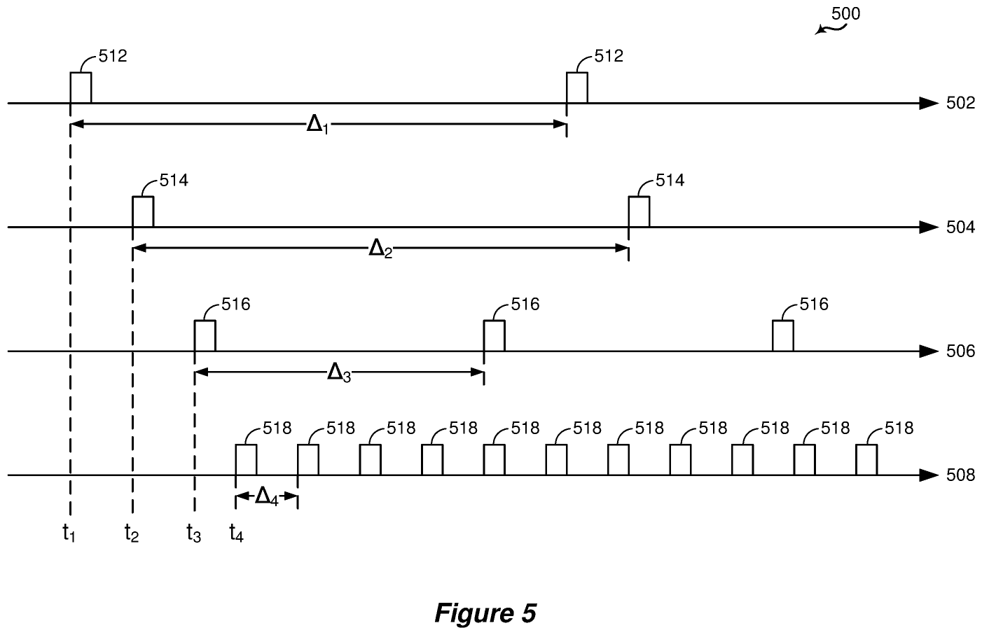

Isochronous events may be used to transmit isochronous PDUs (“isochronous packets”) between STAs 404 via isochronous channels. During an isochronous event exchange between connected STAs 404, master and slave STAs 204 may communicate over a point-to-point logical transport called a Connected Isochronous Stream (CIS) to exchange isochronous data. During an isochronous event exchange between unconnected STAs 204, a broadcasting STA (“broadcaster”) 204 may use a connectionless logical transport called a Broadcast Isochronous Stream (BIS) to broadcast isochronous data to multiple receiving STAs 404 referred to as scanning devices (“scanners”) in a unidirectional, connectionless manner. A BIS is defined by multiple events that occur at regular intervals including, for example, extended advertising events, periodic advertising events, and isochronous group events and isochronous stream events. The broadcasting STA 404 periodically broadcasts periodic advertising events that contain synchronization information, including security information and identification information, for the BIS. Other STAs 404 receiving such periodic advertising events can use the synchronization information to synchronize to the BIS and receive the broadcast data (as described in more detail below with reference to FIG. 5).

The LE isochronous physical channel is characterized by a pseudo-random sequence of PHY channels and by three additional synchronization parameters provided by the broadcasting STA 404, whether it be the master device in a connected configuration or whether it be a connectionless broadcasting device. These synchronization parameters include a channel map that indicates the set of PHY channels used in the piconet, a pseudo random number used as an index into the complete set of PHY channels, and the timing of the first data packet.

FIG. 5 shows a timing diagram 500 illustrating a broadcast isochronous channel and a plurality of advertising channels capable of use by a STA 404 of FIG. 4. In the illustrated implementation, the timing diagram 500 includes a primary advertising channel 502, a secondary advertising channel 504 and a periodic advertising channel 506, in addition to the isochronous channel 508 via which the broadcast isochronous data packets are transmitted. The broadcasting STA 404 broadcasts extending advertising packets 512 via the primary advertising channel 502. For example, each of the extended advertising packets 512 may be an ADV_EXT_IND packet in conformance with the Bluetooth 5.0 Specification. As shown, the broadcasting STA 404 broadcasts an extended advertising packet 512 at time t₁. The broadcasting STA 404 may broadcast subsequent extending advertising packets 512 at regular intervals Δ₁, for example, every second.

Each of these extending advertising packets 512 includes synchronization information enabling scanning STAs 404 to identify, lock onto or otherwise synchronize with the secondary advertising channel 504 to acquire other extended advertising packets 514 that the broadcasting STA 404 broadcasts via the secondary advertising channel 504. For example, each of the extended advertising packets 514 may be an AUX_ADV_IND packet in conformance with the Bluetooth 5.0 Specification. As shown, the broadcasting STA 404 broadcasts an extended advertising packet 514 at time t₂. The broadcasting STA 404 may broadcast subsequent extending advertising packets 514 at regular intervals Δ₂, for example, every second.

Each of these other extending advertising packets 514 includes synchronization information enabling scanning STAs 404 to identify, lock onto or otherwise synchronize with the periodic advertising channel 506 to acquire periodic advertising packets 516 that the broadcasting STA 404 broadcasts via the periodic advertising channel 506. For example, each of the periodic advertising packets 516 may be an AUX_SYNC_IND packet in conformance with the Bluetooth 5.0 Specification. As shown, the broadcasting STA 404 broadcasts a periodic advertising packet 516 at time t₃. The broadcasting STA 404 may broadcast subsequent periodic advertising packets 516 at regular intervals Δ₃, for example, on the order of every second less. Each of periodic advertising packets 516 includes synchronization information enabling receiving devices to identify, lock onto or otherwise synchronize with the broadcast isochronous channel 508 to acquire the broadcast isochronous data packets 518 of the BIS that the broadcasting STA 404 broadcasts via the broadcast isochronous channel 508. As shown, the broadcasting STA 404 broadcasts an isochronous data packet 518 at time t₄. The broadcasting STA 404 may broadcast the isochronous data packets 518 at regular intervals Δ₄, for example, on the order of every second or less.

Isochronous data transfer combines features of both synchronous and asynchronous data transfer. For example, in an isochronous data transfer system, each transmission begins with a start packet. Blocks of data are then transmitted asynchronously. Typically, the data must be transmitted with a guaranteed bandwidth to ensure delivery within specified time constraints. As such, isochronous data transfer may be advantageous in applications including voice traffic, streaming video, and streaming audio (for example, between a mobile smartphone and wireless earbuds. However, isochronous data transfer does not include an error detection mechanism such as an acknowledgement packet because, even if an error was detected, time constraints would prohibit the retransmission of the data.

STAs 404 may implement security features for pairing, bonding, authentication, encryption and message integrity. For example, pairing involves generating one or more shared secret keys, bonding involves storing the keys for use in subsequent connections and authentication involves verifying that two devices have the same keys. Encryption may be used to ensure message confidentiality and message integrity may protect against forgeries.

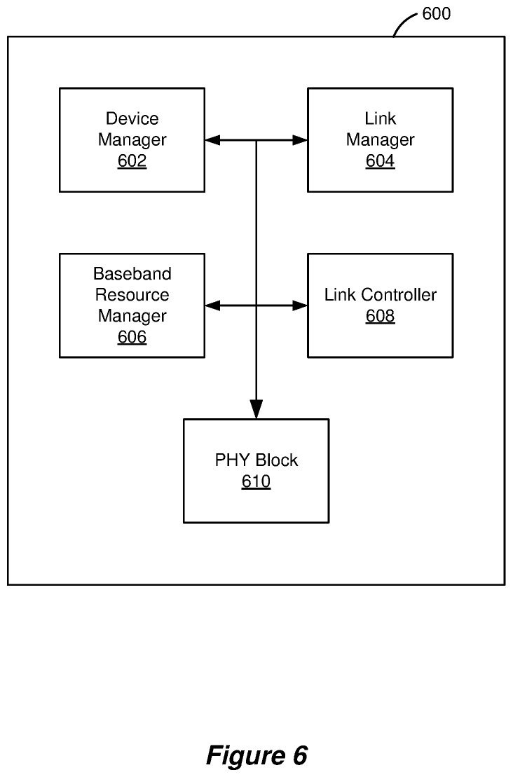

Each STA 404 may generally include several components. FIG. 6 shows a block diagram of an example STA 600 capable of use in the wireless communication network of FIG. 4. For example, the STA 600 may be an example implementation of the STA 404 described with reference to FIG. 4. In the illustrated implementation, the STA 600 includes a device manager 602, a link manager 604, a baseband resource manager 606, a link controller 608 and a PHY block 610, each of which may be implemented by a processor (such as the processor 310), a modem (such as the modem 330), or a combination such components or modules or other components or modules. The device manager 602 controls the general behavior of the Bluetooth system and is responsible for discovery and for connecting to other STAs 600, and generally all operations not directly related to data transport. The link manager 604 is responsible for the creation, modification and termination of logical links (including the associated logical transports) as well as the updating of parameters related to the physical links. The baseband resource manager 606 is responsible for access to the wireless medium and is configured to perform scheduling and to enforce QoS requirements. The link controller 608 is responsible for the encoding and decoding of packets while the PHY block 610 is responsible for the transmission and reception of packets over the physical channels of the wireless medium.

In some examples, a Bluetooth-compliant also may be configured for wireless communication with other networks such as with a Wi-Fi WLAN or a WWAN (for example, a cellular network such as an LTE, 4G or 5G network), which may, in turn, provide access to external networks including the Internet. As such, and as used herein, a wireless communication device, such as one of STAs 404 or 600, may refer to a device that is capable of operating within both a Bluetooth network as well as another type of wireless network, such as a Wi-Fi BSS or within a WWAN cell. To manage coexistence between Bluetooth and WLAN systems, which both operate in the ISM 2.4 GHz band, the use of the shared wireless medium may be time-division multiplexed to ensure that only one of the interfering modems will gain access to the physical wireless medium at any given time. Adaptive frequency hopping also improves coexistence with co-located static (non-hopping) systems.

Isochronous data transfer systems may be susceptible to attacks and authentication challenges. For example, in a connectionless Bluetooth LE implementation using a Broadcast Isochronous Stream (BIS), the broadcaster of the isochronous data must generate and transmit synchronization information to the receiving devices to enable the receiving devices to acquire the BIS and decrypt the isochronous data. The synchronization information includes, in addition to the synchronization parameters (the channel map, pseudo random number and the timing) described above, a Group Initialization Vector (GIV) and a Group Session Key Diversifier (GSKD). The broadcasting device further generates a Group Long Term Key (GLTK) that is then distributed to the receiving devices. Each of the broadcasting and receiving devices may generate an encryption key based on the GLTK and the GSKD.

The GLTK and the GSK are secure but the GSKD and the GIV are not; they are ascertainable by other devices, including would-be attackers, by capturing the periodic advertising packets in which they are transported. Isochronous data transfer systems may thus be susceptible to an abuse of the GLTK. The broadcasting device may distribute the GLTK to receiving devices when pairing with the broadcasting device. Any of these paired devices may then abuse the GLTK by pretending to be the genuine broadcasting device. The impostor or “spoofing device” may then select its own GIV and GSKD and begin broadcasting data to the other receiving devices. Thus, an authentication mechanism is desirable, especially for public announcements in which a large number of receiving devices are expected to be synchronized with the BIS.

Isochronous data transfer systems are also susceptible to replay attacks. In some applications, the broadcasting device may use an incrementing payload counter as a nonce for encrypting the isochronous data transmitted via the BIS to prevent replay attacks. However, even in instances in which a payload counter is utilized, it is still possible for an attacker to capture the periodic advertising packets, and thus ascertain the GSKD and the GIV. The attacker may then capture encrypted broadcast packets and replay them at a later time giving rise to a replay attack. Generally, a receiving device has no way of determining whether received broadcast packets are proper or “fresh” or whether they have been replayed. Notably, the attacker does not need to know the GLTK to perform such a replay attack. Rather, the attack is made possible because the broadcasting device is solely responsible for computing or otherwise determining the GSKD and the GIV; that is, the broadcasting device does not use input from the receiving devices.

In contrast, reply attacks are not possible when the transmitting and receiving devices utilize LE ACL or a Connected Isochronous Stream (CIS) for which both the master and slave devices contribute to the session key diversifier and the initialization vector. For example, in such LE ACL applications, a link manager of the master device generates a master's part of the initialization vector (IVmaster) and a master's part of the session key diversifier (SKDmaster) using a random number generator. The master device then transmits IVmaster and SKDmaster to the slave device. The slave device receives IVmaster and SKDmaster and generates IVslave and SKDslave using a random number generator. The slave device then generates a SKD for the session based on a concatenation of SKDmaster and SKDslave. Similarly, the slave generates an IV for the session based on a concatenation of IVmaster and IVslave. The slave device then transmits IVslave and SKD slave to the master device, which the master device then uses to generate the SKD the IV. The master/slave may then utilize an encryption engine to generate a session key (SK) using a long term key (LTK) and the SKD as input.

Various implementations relate generally to wireless communications, and more specifically, to authenticating data transmissions using asymmetric and symmetric encryption techniques. Some implementations more specifically relate to authentication techniques for authenticating broadcast isochronous data streams. The authentication techniques include the generation and verification of a digital signature. The broadcasting device generates and broadcasts synchronization information enabling receiving devices to acquire the broadcast isochronous data. In some implementations, the broadcasting device generates the digital signature by certifying a combination of a nonce and the synchronization information using a private key. In some implementations, a receiving device receives the digital signature, verifies it to ensure the integrity of the certified nonce and synchronization information, and uses the certified information to authenticate subsequently received broadcast isochronous data.

In some implementations or respects, the authentication operations can be divided into asymmetric and symmetric operations. For example, the disclosed authentication techniques can utilize both an asymmetric encryption procedure as well as a symmetric encryption procedure. For example, the asymmetric encryption operations can include, on the transmitter side, the generation of authentication data including a digital signature and, on the receiver side, the verification of the digital signature. The symmetric encryption operations can include, on the transmitter side, the generation of an encryption key (a session key) and the encryption of both the authentication information and the subsequent data using the encryption key. Similarly, the symmetric encryption can include, on the receiver side, the generation of an encryption key and the decryption of the authentication information and the subsequent data using the encryption key.

Particular implementations of the subject matter described in this disclosure can be implemented to realize one or more of the following potential advantages. In some implementations, the described techniques can be used to authenticate wireless communications including broadcast isochronous data transmissions. For example, the described authentication techniques can be used to prevent the abuse of a LTK as well as to prevent replay attacks. Additionally, various implementations provide scalability to a virtually unlimited number of receiving devices because the authentication does not rely on an exchange of authentication requests and authentication responses as is typical in conventional authentication techniques.

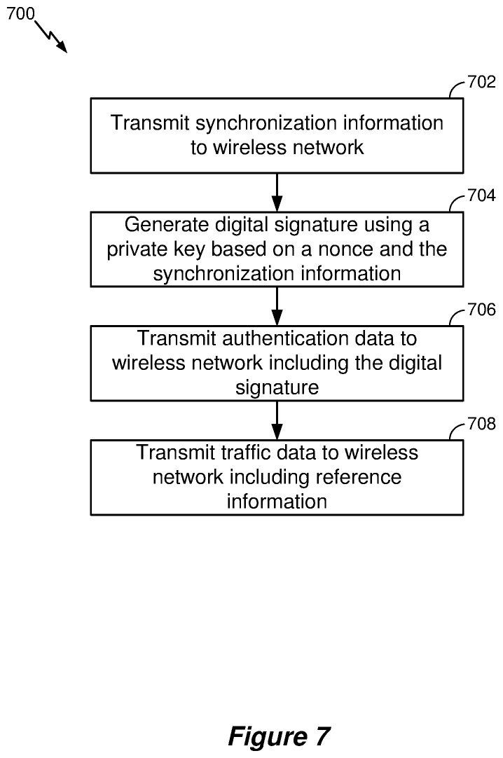

FIG. 7 shows a flowchart illustrating an example process 700 for wireless communication by a transmitting device according to some implementations. In some implementations, the process 700 may be performed by a wireless communication device such as one of the STAs 404 or 600 described above with reference to FIGS. 4 and 6, respectively. In some implementations, the process 700 can be implemented by a transmitting device (also referred to herein as the “broadcasting device”) for use in broadcasting or otherwise transmitting data to one or more receiving devices (also referred to herein as “scanning devices”) in a secure manner.

In some implementations, the process 700 begins in block 702 with transmitting synchronization information (or “synchronization data”) for wireless communications with a wireless network that includes at least one receiving device. In block 704, the process 700 proceeds with generating a digital signature using a private key based on a nonce and at least a portion of the synchronization information. The transmitting device transmits authentication information (or “authentication data”) to the wireless network in block 706, the authentication information including the digital signature. In block 708, the transmitting device transmits at least one data packet including data (hereinafter also referred to as “traffic data” for didactic purposes to distinguish from the synchronization information and authentication information) to the wireless network. The transmitting device includes corresponding reference information with the traffic data in the respective data packets. The authentication information including the digital signature can be verified by the receiving devices using a public key. A receiving device may subsequently use the verified digital signature in conjunction with the reference information to authenticate that the received data packets are not part of a replay attack, and more generally, authenticate the device transmitting the traffic data as the true transmitting device from which the authentication information was received.

As a person having ordinary skill in the art will appreciate, although the operations of the process 700 are illustrated and described as ordered blocks or steps, the operations within each of the blocks may be ongoing or periodic and the blocks may overlap or otherwise be rearranged. For example, the transmitting device may periodically transmit the synchronization information or the authentication information to the wireless network or may periodically or otherwise generate a new public and private key pair under certain conditions.

As described above, the transmitting device can be configured for broadcast isochronous communications and the receiving devices can be part of a broadcast isochronous group (BIG) of the wireless network. In such implementations, the transmitting device may broadcast the traffic data to the BIG in block 710 in the form of a broadcast isochronous stream (BIS) of isochronous data packets including isochronous data and the reference information. The transmitting device also may broadcast the synchronization information to the BIG in block 704 and broadcast the authentication information to the BIG in block 708.

The synchronization information for the BIG generally includes information enabling any receiving devices within the BIG to identify, lock onto or otherwise synchronize with the BIS to acquire the isochronous data packets. For example, the synchronization information may include a channel map that indicates the set of PHY channels used in the piconet, a pseudo random number used as an index into the complete set of PHY channels, and the timing of the first data packet. The synchronization information also includes security information for the BIG, such as, for example, a Group Initialization Vector (GIV) and a Group Session Key Diversifier (GSKD). The GIV enables the receiving devices in the BIG to decrypt received packets. The transmitting device may generate the GIV using any suitable techniques including using a random number generator. The GSKD enables the receiving devices within the BIG to generate encryption keys for use in decrypting the received packets, including the isochronous data packets of the BIS. The transmitting device may generate the GSKD using any suitable techniques including using a random number generator.

As just described, in various implementations, the transmitting device encrypts the isochronous data prior to broadcasting the isochronous data packets. To establish an encryption key for the BIS, the transmitting device also generates a secret key referred to as the Group Long Term Key (GLTK). In some implementations, the transmitting device also transmits or otherwise shares the GLTK with the devices in the BIG during previous pairing operations with the other devices or via any other suitable techniques. The transmitting device can then generate an encryption key, referred to as a Group Session Key (GSK), based on the GLTK and the GSKD for use in encrypting the broadcast isochronous data. In such implementations, the transmitting device may also encrypt the authentication information using the same encryption key prior to broadcasting the authentication information. Similarly, each of the receiving devices within the BIG, having obtained the GLTK and the GSKD, can generate the encryption key based on the GLTK and the GSKD for use in decrypting the received broadcast isochronous data and authentication information.

As described above, in block 706, the transmitting device generates the digital signature using the private key based on a nonce and at least a portion of the synchronization information. In some implementations, to generate the digital signature the transmitting device executes a digital signature algorithm (DSA) that certifies the nonce and the synchronization information (for example, a combination of the GSKD and the GIV) using the private key. For example, the DSA may be an Elliptic Curve Digital Signature Algorithm (ECDSA). In some implementations, the DSA may take as input the nonce and a concatenation of the GSKD and the GIV and certify (or “sign”) the combination of the nonce and the concatenation of the GSKD and the GIV using the private key. By way of example, the DSA may generate a one-way hash of the nonce, the GSKD and the GIV and then use the private key to encrypt the hash, returning a value that is unique to the hashed data. The encrypted hash, along with other information associated with the hashing algorithm, may form the digital signature. The digital signature thus represents the certified combination and may be verified by a receiving device to determine that the nonce and the synchronization information have not been tampered with. For example, the digital signature is mathematically bound to the data (the nonce and synchronization information) it was originally made with, and as such, verification will fail for practically any other data, no matter how similar to the original data. Any change in the data, even to a single bit, may result in a different hash value. The receiving device may verify the digital signature, and thus validate the integrity of the nonce and synchronization information, using a public key of the transmitting device to verify the hash. For example, the receiving device may generate a hash of the same data and compare it to the received hash. If the hashes match, it proves that the data hasn't changed since it was signed. If the two hashes don't match, the data has either been tampered with in some way (indicating a failure of integrity) or the signature was created with a private key that doesn't correspond to the public key obtained by the receiving device (indicating a failure of authentication).

In various implementations, the nonce includes timing information. For example, the nonce can be or can include a timestamp, such as a global timestamp, indicating a current date and time or other date and time associated with the synchronization information or traffic data. In some other implementations, the nonce can include a broadcast counter, packet counter or payload counter (hereinafter also referred to simply as a “counter”) associated with the synchronization information or traffic data. In such implementations, the reference information transmitted with the traffic data can include timing information, such as a global timestamp or payload counter, that can then be compared by the receiving devices with the timing information in the certified nonce to authenticate that the received data packets are not part of a replay attack, and more generally, to authenticate the device transmitting the traffic data as the true transmitting device from which the authentication information was received.

The transmitting device may obtain the private key using any suitable techniques. For example, the transmitting device may generate the private key as part of a public and private key pair using a random number generator. The transmitting device may distribute the public key to each of the devices of the BIG using any suitable techniques. For example, in some instances the transmitting device also transmits or otherwise shares the public key with the receiving devices within the BIG during previous pairing operations with the other devices. In some other cases, the transmitting device may set up an encrypted link with one or more of the receiving devices within the BIG through Generic Attributes (GATT) or through the Security Manager Protocol (SMP) and transmit the public key to the devices via the respective encrypted links. In some other situations, the transmitting device may transmit a uniform resource identifier (URI) to one or more of the receiving devices within the BIG identifying a remote storage location from which the devices can retrieve the public key. In some implementations, the transmitting device associates an expiration time with the public and private key pair. In such instances, the transmitting device may generate a new public and private key pair responsive to the expiration of the expiration time. The transmitting device may then again distribute the new public key to the receiving devices. Because the authentication data including the digital signature is only good as long as the private and public key pair is valid, the use of expiring key pair may improve security.

As described above, the transmitting device may transmit the synchronization information to the wireless network in block 704 by periodically broadcasting the synchronization information for the BIS in periodic advertising packets. In some implementations, the transmitting device broadcasts the authentication information to the wireless network in block 708 by including the authentication information in the same periodic advertising packets it broadcasts in block 704, which already include the synchronization information. For example, the transmitting device can include the nonce, at least a portion of the synchronization information (such as a concatenation of the GSKD and the GIV), and the digital signature in a BIG synchronization information field within each of some or all of the periodic advertising packets.

In some other implementations, the transmitting device may broadcast the authentication information to the wireless network in block 708 by broadcasting the authentication information in other advertising packets. For example, the transmitting device may broadcast additional periodic advertising packets in block 708 that each include several fields. For example, each of these periodic advertising packets can include a first field including opcode, a second field including timing information, a third field including at least a portion of the synchronization information (such as a concatenation of the GSKD and the GIV), and a fourth field including the digital signature. The opcode may indicate to the receiving devices that the advertising packet includes authentication information.

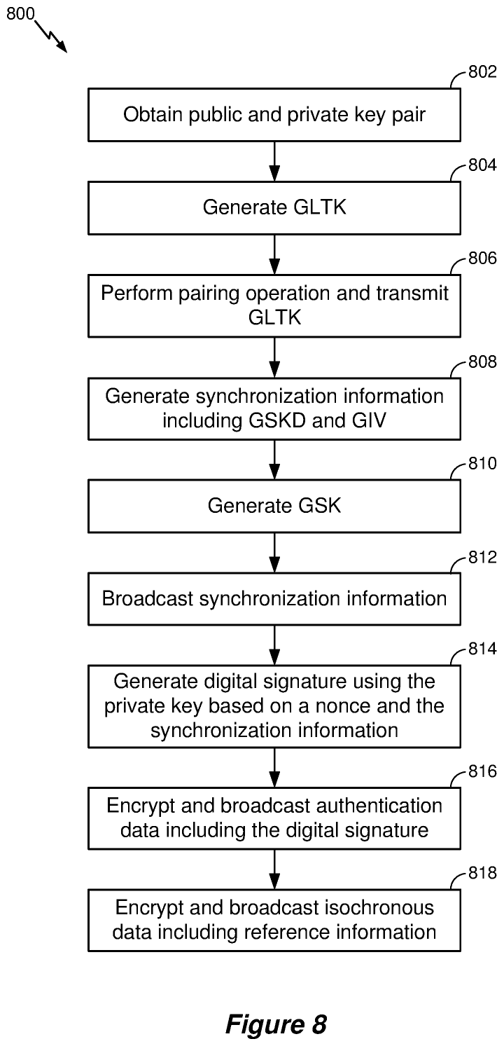

FIG. 8 shows a flowchart illustrating an example process 800 for wireless communication by a broadcasting device according to some implementations. In some implementations, the process 800 may be performed by a wireless communication device such as one of the STAs 404 or 600 described above with reference to FIGS. 4 and 6, respectively. In some implementations, the process 800 can be implemented by a broadcasting device for use in broadcasting isochronous data to one or more scanning devices in a secure manner. For example, the process 800 may be an example implementation of the process 700 described with reference to FIG. 7.

In some implementations, the process 800 begins in block 802 with the broadcasting device obtaining a public and private key pair for broadcast isochronous communications with a BIG that includes at least one scanning device. In block 804, the broadcasting device generates a GLTK for the BIG. In block 806, the broadcasting device performs a pairing operation and pairs with at least one scanning device of the BIG. In some implementations, the broadcasting device transmits the GLTK to the scanning device during the pairing operation. In block 808, the broadcasting device generates synchronization information for the BIG including a GIV and a GSKD. In block 810, the broadcasting device generates a GSK based on the GLTK and the GSKD. In block 812, the broadcasting device broadcasts the synchronization information to the wireless network in at least one advertising packet.

In block 814, the broadcasting device generates a digital signature using the private key based on a nonce, the GSKD and the GIV. In some implementations, the nonce includes timing information. For example, the nonce can be or can include a timestamp, such as a global timestamp, indicating a current date and time or other date and time associated with the synchronization information or with subsequent data. In some other implementations, the nonce can include a broadcast or payload counter associated with the synchronization information or other data. In block 816, the broadcasting device encrypts authentication information using the GSK, the authentication information including the digital signature, and broadcasts the encrypted authentication information to the wireless network in at least one advertising packet. In block 818, the broadcasting device encrypts isochronous data based on the GSK and broadcasts the encrypted isochronous data to the wireless network in at least one isochronous data packet. The isochronous data packets further include corresponding reference information with the respective isochronous data. The authentication information including the digital signature can be verified by the scanning devices in the BIG using a public key. A scanning device may subsequently use the verified digital signature in conjunction with the reference information to authenticate the isochronous data as being received from the broadcasting device. In other words, the scanning device may use the verified digital signature in conjunction with the reference information to authenticate a transmitting device from which the traffic data was received as the true broadcasting device from which the authentication information was received.

As a person having ordinary skill in the art will appreciate, although the operations of the process 800 are illustrated and described as ordered blocks or steps, the operations within each of the blocks may be ongoing or periodic and the blocks may overlap or otherwise be rearranged. For example, the broadcasting device may periodically broadcast the synchronization information or the authentication information to the wireless network or may periodically or otherwise generate a new public and private key pair under certain conditions.

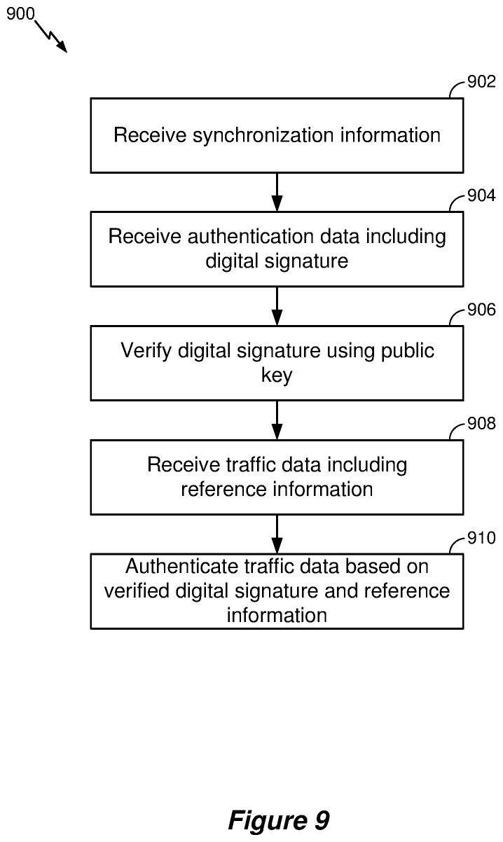

FIG. 9 shows a flowchart illustrating an example process 900 for wireless communication by a receiving device according to some implementations. In some implementations, the process 900 may be performed by a wireless communication device such as one of the STAs 404 or 600 described above with reference to FIGS. 4 and 6, respectively. In some implementations, the process 900 can be implemented by a receiving device (also referred to herein as a “scanning device”) for use in receiving data from a transmitting device (also referred to herein as a “broadcasting device”) in a secure manner.

In some implementations, the process 900 begins in block 902 with the receiving device receiving synchronization information for wireless communications from a transmitting device. The process 900 proceeds in block 904 with receiving, from the transmitting device, authentication information for the wireless communications including a digital signature of the transmitting device, the digital signature being based on a nonce and a combination of the synchronization information. The receiving device may then verify the digital signature using a public key in block 906. In block 908, the receiving device receives, based on at least a portion the synchronization information, traffic data and corresponding reference information included with the traffic data. The traffic data may be received in data packets that include the respective reference information. In block 910, the receiving device may then authenticate, based on the verified digital signature and the reference information, that the received data packets are not part of a replay attack, and more generally, authenticate the device transmitting the traffic data as the true transmitting device from which the authentication information was received.

As a person having ordinary skill in the art will appreciate, although the operations of the process 900 are illustrated and described as ordered blocks or steps, the operations within each of the blocks may be ongoing or periodic and the blocks may overlap or otherwise be rearranged. For example, the receiving device may periodically receive the synchronization information or the authentication information.

As described above, the receiving device can be configured for broadcast isochronous communications and be part of a broadcast isochronous group (BIG). In such implementations, the receiving device may receive the traffic data in block 908 in the form of a broadcast isochronous stream (BIS) of isochronous data packets including isochronous data and the reference information. The synchronization information for the BIG generally includes information enabling any receiving devices within the BIG to identify, lock onto or otherwise synchronize with the BIS to acquire the isochronous data packets. For example, the synchronization information may include a channel map that indicates the set of PHY channels used in the piconet, a pseudo random number used as an index into the complete set of PHY channels, and the timing of the first isochronous data packet. The synchronization information also includes security information for the BIG, such as, for example, a GIV and a GSKD. The GIV enables the receiving devices in the BIG to decrypt received packets. The GSKD enables the receiving devices within the BIG to generate encryption keys for use in decrypting the received packets, including the isochronous data packets of the BIS.

As just described, in various implementations, the transmitting device encrypts the isochronous data prior to broadcasting the isochronous data packets. To establish an encryption key for decrypting the isochronous data, the receiving device also obtains a GLTK. In some implementations, the receiving device receives the GLTK during a previous pairing operation with the transmitting device or via any other suitable techniques. The receiving device can then generate the encryption key (a GSK) based on the GLTK and the GSKD for use in decrypting the broadcast isochronous data. In such implementations, the transmitting device may also encrypt the authentication information using the same encryption key prior to broadcasting the authentication information.

As described above, the authentication information includes a digital signature of the transmitting device, which may be based on a nonce and a combination of the synchronization information. For example, the transmitting device may generate the digital signature using a private key of a key pair that includes the public key. As described above, to generate the digital signature, the transmitting device may execute a DSA that certifies the nonce and a combination of the GSKD and the GIV using the private key.

In some implementations, the receiving device verifies the digital signature in block 906 by executing a DSA that takes as input the digital signature and the public key and that indicates that the content of the digital signature (including the nonce and the combination of the GSKD and the GIV) has been certified using a private key of the transmitting device. For example, the receiving device may verify the digital signature, and thus validate the integrity of the nonce, the GSKD and the GIV), using the public key to verify the hash created by the DSA at the transmitting device using the corresponding private key. The receiving device may then generate a hash of the same data—the nonce and the combination of the GSKD and the GIV. If the receiving device determines that the received hash matches the hash it generated, it proves that the data hasn't changed since it was signed. If the two hashes don't match, the data has either been tampered with in some way (indicating a failure of integrity) or the signature was created with a private key that doesn't correspond to the public key obtained by the receiving device (indicating a failure of authentication). The receiving device may store all or a portion of the verified digital signature, for example, the verified nonce and verified synchronization information.

In various implementations, the nonce includes timing information. For example, the nonce can be or can include a timestamp, such as a global timestamp, indicating a date and time associated with the synchronization information or traffic data. In some other implementations, the nonce can include a counter associated with the synchronization information or traffic data. In such implementations, the reference information transmitted with the traffic data can include timing information, such as a global timestamp or payload counter. The receiving device can then, in block 910, compare the timing information transmitted with the traffic data to the timing information in the certified nonce to determine whether the transmitted data has been received within a threshold duration of time or within a threshold number of packets or payloads since the receipt or verification of the digital signature. The threshold duration of time may be a duration of time typically associated with a communication session, such as a broadcast session. For example, the threshold duration of time may be on the order of a few minutes (for example, five minutes). The threshold number of packets or payloads may be typically associated with a communication session, such as a broadcast session. In this way, at least in part, the receiving device can authenticate that the received data packets are not part of a replay attack, and more generally, authenticate the device transmitting the traffic data as the true transmitting device from which the authentication information was received.

The receiving device may obtain the public key using any suitable techniques. For example, in some instances the transmitting device also transmits or otherwise shares the public key with the receiving device during a previous pairing operation. In some other cases, the transmitting device may set up an encrypted link with the receiving device through GATT or through SMP and transmit the public key to the receiving device via the encrypted link. In some other situations, the transmitting device may transmit a URI to the receiving device identifying a remote storage location from which the receiving device can retrieve the public key. In some implementations, the transmitting device associates an expiration time with the public key. In such instances, the receiving device may obtain a new public key responsive to the expiration of the expiration time. Because the authentication data including the digital signature is only verifiable as long as the public key is valid, the use of an expiring key may improve security.

As described above, the receiving device may periodically receive the synchronization information in block 904 in broadcast periodic advertising packets. In some implementations, the receiving device also may periodically receive the authentication information in block 906 in the same periodic advertising packets that include the synchronization information. For example, the transmitting device can include the nonce, at least a portion of the synchronization information (such as a concatenation of the GSKD and the GIV), and the digital signature in a BIG synchronization information field within each of some or all of the periodic advertising packets.

In some other implementations, the transmitting device may broadcast the authentication information to the wireless network in other advertising packets distinct from the periodic advertising packets in which the synchronization information is included. For example, the transmitting device may broadcast advertising packets that each include several fields. For example, each of these additional advertising packets can include a first field including opcode, a second field including timing information, a third field including at least a portion of the synchronization information (such as a concatenation of the GSKD and the GIV), and a fourth field including the digital signature. The opcode may indicate to the receiving devices that the advertising packet includes authentication information.

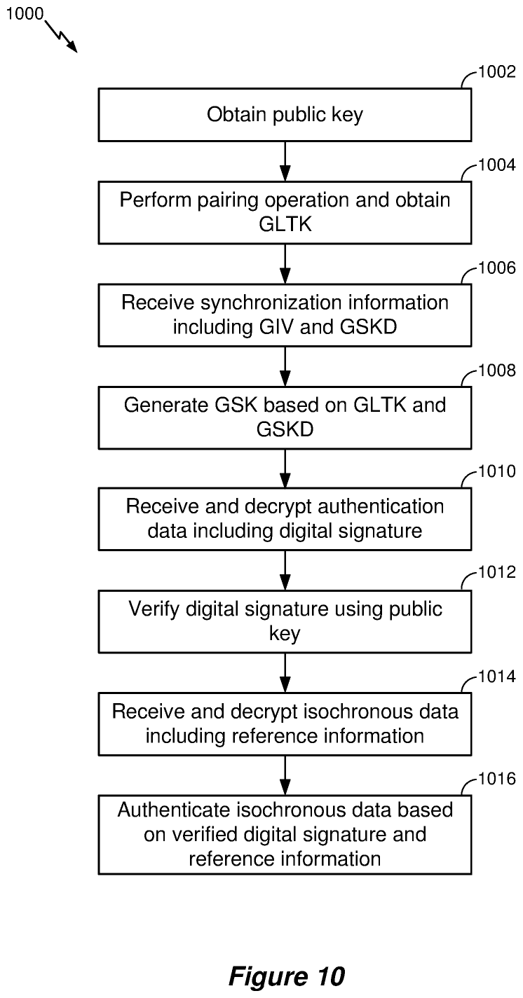

FIG. 10 shows a flowchart illustrating an example process 1000 for wireless communication by a scanning device according to some implementations. In some implementations, the process 1000 may be performed by a wireless communication device such as one of the STAs 404 or 600 described above with reference to FIGS. 4 and 6, respectively. In some implementations, the process 1000 can be implemented by a scanning device for use in receiving broadcast isochronous data in a secure manner. For example, the process 1000 may be an example implementation of the process 900 described with reference to FIG. 9.

In some implementations, the process 1000 begins in block 1002 with the scanning device obtaining a public key for broadcast isochronous communications from a broadcasting device. In block 1004, the scanning device performs a pairing operation with the broadcasting device. In some implementations, the scanning device obtains a GLTK for the BIG from the broadcasting device during the pairing operation. In block 1006, the receiving device receives synchronization information for the BIG in at least one advertising packet, the synchronization information including a GIV and a GSKD. In block 1008, the receiving device generates a GSK based on the GLTK and the GSKD.

In block 1010, the receiving device receives encrypted authentication information, including a digital signature of the broadcasting device, and decrypts the authentication information using the GSK. The digital signature is based on a nonce and a combination of the synchronization information, for example, a concatenation of the GSKD and the GIV. In some implementations, the nonce includes timing information. For example, the nonce can be or can include a timestamp, such as a global timestamp, indicating a date and time. In some other implementations, the nonce can include a broadcast or payload counter. In block 1012, the receiving device verifies the digital signature using a public key.

In block 1014, the receiving device receives, based on at least a portion the synchronization information, encrypted isochronous data in at least one isochronous data packet and decrypts the isochronous data using the GSK. The isochronous data packets further include corresponding reference information with the respective isochronous data. In block 1016, the receiving device may then authenticate, based on the verified digital signature and the reference information, the isochronous data as being received from the broadcasting device. In other words, the scanning device may use the verified digital signature in conjunction with the reference information to authenticate that the received data packets are not part of a replay attack, and more generally, to authenticate the device transmitting the traffic data as the true transmitting device from which the authentication information was received.

As a person having ordinary skill in the art will appreciate, although the operations of the process 1000 are illustrated and described as ordered blocks or steps, the operations within each of the blocks may be ongoing or periodic and the blocks may overlap or otherwise be rearranged. For example, the scanning device may periodically receive the synchronization information or the authentication information.

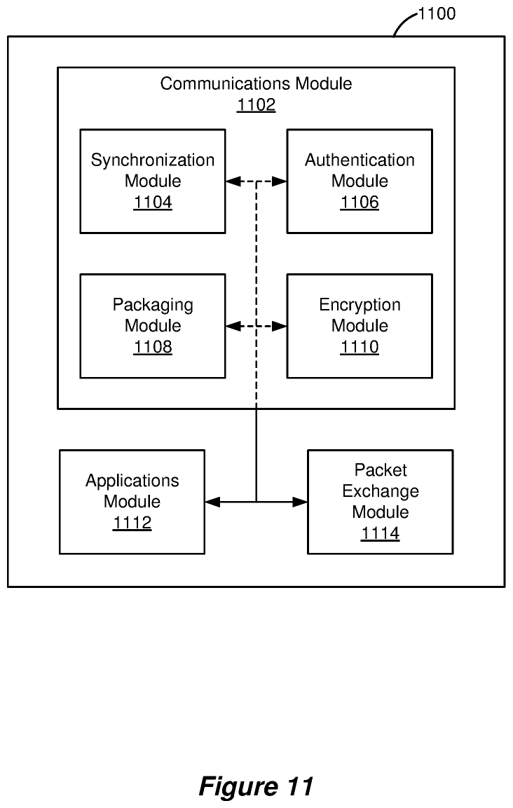

FIG. 11 shows a block diagram of an example wireless communication device 1100 for use in wireless communication according to some implementations. In some implementations, the wireless communication device 1100 can be an example of one or more of the STAs 104, 300, 404 or 600 described above with reference to FIGS. 1, 3, 4 and 6, respectively. In some implementations, the wireless communication device 1100 is configured to perform one or both of the processes 700 or 800 described above with reference to FIGS. 7 and 8, respectively. Additionally, in some implementations, the wireless communication device 1100 may further be configured to perform one or both of the processes 900 or 1000 described above with reference to FIGS. 9 and 10, respectively. The wireless communication device 1100 includes a communications module 1102, an applications module 1112, and a packet exchange module 1114. The communications module 1102, in turn, includes a synchronization module 1104, an authentication module 1106, a packaging module 1108 and an encryption module 1110.

Portions of one or more of the modules 1102, 1112 and 1114 may be implemented at least in part in hardware or firmware. For example, portions of the communications module 1102 and the packet exchange module 1114 may be implemented at least in part by one or more modems (for example, a Bluetooth modem). In some implementations, at least some of the modules 1102, 1112 and 1114 are implemented at least in part as software stored in a memory (such as the memory 320 described with reference to FIG. 3). For example, portions of one or more of the modules 1102, 1112 and 1114 can be implemented as non-transitory instructions (or “code”) executable by at least one processor (such as the processor 310 described with reference to FIG. 3) to perform the functions or operations of the respective module. In some implementations, the synchronization module 1104 may be implemented, at least in part, by a link manager (such as the link manager 604 described above with reference to FIG. 6). As another example, the authentication module 1106 may be implemented, at least in part, by a device manager (such as the device manager 602 described with reference to FIG. 6). As another example, the packaging module 1108 may be implemented, at least in part, by a baseband resource manager (such as the baseband resource manager 606 described with reference to FIG. 6). As another example, the encryption module 1110 may be implemented, at least in part, by a link controller (such as the link controller 608 described above with reference to FIG. 6). As another example, the packet exchange module 1114 may be implemented, at least in part, by a link controller and a PHY block (such as the link controller 608 and the PHY block 610 described with reference to FIG. 6).

The communications module 1102 is generally configured to manage wireless communications with a wireless network including providing for synchronization, encryption, authentication and data packaging. For example, the synchronization module 1104 may be configured to generate synchronization information and to provide the synchronization information to the packaging module 1108 for subsequent packet exchange module 1114 for transmission to the wireless network. For example, in BIG implementations, the synchronization information generally includes information enabling any receiving devices within the BIG to identify, lock onto or otherwise synchronize with a BIS to acquire isochronous data packets. For example, the synchronization information may include a channel map that indicates the set of PHY channels used in the piconet, a pseudo random number used as an index into the complete set of PHY channels, and the timing of the first isochronous data packet. The synchronization information also includes security information for the BIG, such as, for example, a GIV and a GSKD. The synchronization module 1104 may generate the GIV and the GSKD using any suitable techniques including using a random number generator.

The authentication module 1106 is configured to generate authentication information including a digital signature and to provide the authentication information to the packet exchange module 1114 for transmission to the wireless network. As described above, the authentication module 1106 may generate the digital signature using a private key based on a nonce and at least a portion of the synchronization information. In some implementations, to generate the digital signature the authentication module 1106 executes a digital signature algorithm (DSA) that certifies the nonce and a combination of the GSKD and the GIV using the private key. For example, the DSA may take as input the nonce and a concatenation of the GSKD and the GIV and certify the combination of the nonce and the concatenation of the GSKD and the GIV using the private key. The resulting output of the DSA is a digital signature that represents the certified combination and that may be verified by a receiving device to determine that the nonce and the synchronization information have not been tampered with.

The applications module 1106 is configured to generate, relay or otherwise provide data (such as broadcast data including audio, video or other streaming content) from one or more applications executing on a processor to the packaging module 1108. The packaging module 1108 is configured to collect, aggregate, divide or otherwise package the data received from the applications module 1112, the synchronization module 1104 and the authentication module 1106. The packaging module 1108 is also responsible for scheduling the transmission of the packaged data and for providing the scheduled data to the encryption module 1110 for subsequent encryption or directly to the packet exchange module 1114 for packetizing and transmission to the wireless network.

The encryption module 1110 is configured to encrypt data, such as isochronous data, received from the packaging module 1108. For example, to establish an encryption key for a BIS, the encryption module 1110 generates a secret key, such as a GLTK. The encryption module 1110 generates an encryption key, a GSK, based on the GLTK and the GSKD for use in encrypting the broadcast isochronous data. In such implementations, the encryption module 1110 also may encrypt the authentication data using the encryption key prior to broadcasting the authentication data.

The packet exchange module 1114 is configured to generate, receive and perform the initial processing of packets such as Bluetooth packets or Wi-Fi packets. For example, the packet exchange module 1114 may be configured to generate advertising packets and data packets including isochronous packets. For example, the packet exchange module 1114 may generate periodic advertising packets that include synchronization information or authentication information received from the synchronization module 1104 and the authentication module 1106, respectively. The packet exchange module 1114 also is configured to generate data packets, such as broadcast isochronous data packets, that include encrypted data from the encryption module 1110 or unencrypted data directly from the packaging module 1108.

One or both of the packet exchange module 1114 or the packaging module 1108 is further configured to embed or otherwise include reference information corresponding to the data. As described above, the reference information transmitted with the data can include timing information, such as a global timestamp or payload counter associated with the data. In such implementations, the nonce also may include timing information. For example, the nonce can be or can include a timestamp, such as a global timestamp, or a payload counter. Receiving devices receiving the data can then compare the reference (timing) information received with the data to reference (timing) information in the certified nonce to authenticate that the received data packets are not part of a replay attack, and more generally, authenticate the wireless communication device 1100 as the true transmitting device from which the authentication information was received.

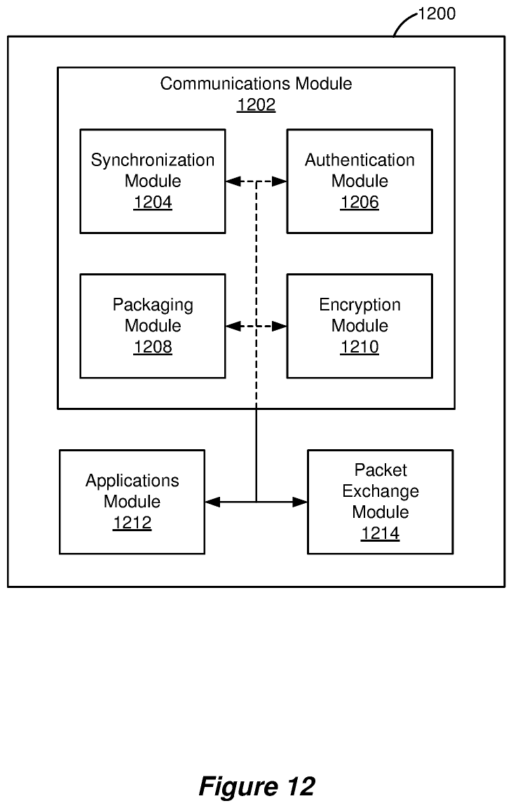

FIG. 12 shows a block diagram of an example wireless communication device 1200 for use in wireless communication according to some implementations. In some implementations, the wireless communication device 1200 can be an example of one or more of the STAs 104, 300, 404 or 600 described above with reference to FIGS. 1, 3, 4 and 6, respectively. In some implementations, the wireless communication device 1200 is configured to perform one or both of the processes 900 or 1000 described above with reference to FIGS. 9 and 10, respectively. Additionally, in some implementations, the wireless communication device 1200 may further be configured to perform one or both of the processes 700 or 800 described above with reference to FIGS. 7 and 8, respectively, and as such, may include the components of the wireless communication device 1100 described with reference to FIG. 11. The wireless communication device 1200 includes a communications module 1202, an applications module 1212, and a packet exchange module 1214. The communications module 1202, in turn, includes a synchronization module 1204, an authentication module 1206, a packaging module 1208 and an encryption module 1210.

Portions of one or more of the modules 1202, 1212 and 1214 may be implemented at least in part in hardware or firmware. For example, portions of the communications module 1202 and the packet exchange module 1214 may be implemented at least in part by one or more modems (for example, a Bluetooth modem). In some implementations, at least some of the modules 1202, 1212 and 1214 are implemented at least in part as software stored in a memory (such as the memory 320 described with reference to FIG. 3). For example, portions of one or more of the modules 1202, 1212 and 1214 can be implemented as non-transitory instructions (or “code”) executable by at least one processor (such as the processor 310 described with reference to FIG. 3) to perform the functions or operations of the respective module. In some implementations, the synchronization module 1204 may be implemented, at least in part, by a link manager (such as the link manager 604 described above with reference to FIG. 6). As another example, the authentication module 1206 may be implemented, at least in part, by a device manager (such as the device manager 602 described with reference to FIG. 6). As another example, the packaging module 1208 may be implemented, at least in part, by a baseband resource manager (such as the baseband resource manager 606 described with reference to FIG. 6). As another example, the encryption module 1210 may be implemented, at least in part, by a link controller (such as the link controller 608 described above with reference to FIG. 6). As another example, the packet exchange module 1214 may be implemented, at least in part, by a link controller and a PHY block (such as the link controller 608 and the PHY block 610 described with reference to FIG. 6).

The communications module 1202 is generally configured to manage wireless communications with a wireless network including providing for synchronization, decryption, authentication and data unpackaging. For example, the synchronization module 1204 may be configured to receive synchronization information received from the packet exchange module 1214, and to use the synchronization information to generate identification and acquisition information for acquiring data communicated via a wireless communication channel, such as isochronous data communicated via an isochronous channel in the form of a BIS. The synchronization module 1204 may provide the identification and acquisition information to the packet exchange module 1114 for use in acquiring subsequently received traffic data. For example, in BIG implementations, the synchronization information generally includes information enabling any receiving devices within the BIG to identify, lock onto or otherwise synchronize with a BIS to acquire isochronous data packets. For example, the synchronization information may include a channel map that indicates the set of PHY channels used in the piconet, a pseudo random number used as an index into the complete set of PHY channels, and the timing of the first data packet. The synchronization information also includes security information for the BIG, such as, for example, a GIV and a GSKD.

The authentication module 1206 is configured to receive authentication information, including a digital signature, received from the packet exchange module 1214. As described above, the digital signature may be a certified combination of a nonce and synchronization information. The authentication module 1206 is configured to verify the digital signature using a public key. In some implementations, to verify the digital signature the authentication module 1206 executes a DSA that takes as input the digital signature and the public key and that indicates that the content of the digital signature (for example, including the nonce and a combination of a GSKD and a GIV) has been certified using a private key of the transmitting device. In other words, the receiving device may verify the digital signature to determine that the nonce and the synchronization information have not been tampered with. As described above, the digital signature is mathematically bound to the information (the nonce and synchronization information) it originally was made with, and as such, verification will fail for practically any other information, no matter how similar to the original information.

The authentication module 1206 may store all or a portion of the verified digital signature. The authentication module 1206 is also configured to authenticate subsequently received traffic data based on the verified digital signature and reference information included with the traffic data. In other words, the authentication module 1206 may use the verified digital signature in conjunction with the reference information to authenticate the traffic data. As described above, the nonce may include timing information, such as a global timestamp or payload counter. In such implementations, the reference information transmitted with the data also can include timing information. The authentication module 1206 may then compare the timing information transmitted with the traffic data to the timing information in the certified nonce to determine whether the transmitted data has been received within a threshold duration of time or within a threshold number of packets or payloads since the receipt or verification of the digital signature. The threshold duration of time may be a duration of time typically associated with a communication session, such as a broadcast session. For example, the threshold duration of time may be on the order of a few minutes (for example, five minutes). The threshold number of packets or payloads may be typically associated with a communication session, such as a broadcast session. In this way, at least in part, the receiving device can authenticate that the received data packets are not part of a replay attack, and more generally, authenticate the device transmitting the traffic data as the true transmitting device from which the authentication information was received.

The packaging module 1208 is configured to unpack data received from the packet exchange module 1214 including traffic data (for example, isochronous data such as broadcast audio, video or other streaming content), synchronization information, and authentication information, and to provide the unpacked data to the applications module 1212, the synchronization module 1204 and the authentication module 1206, respectively. The packaging module 1208 also may provide the unpacked data to the encryption module 1210 for subsequent decryption prior to provision to the other modules. For example, to establish an encryption key for a BIS, the encryption module 1210 obtains a secret key, such as a GLTK. In some implementations, the encryption module 1210 receives the GLTK as a result of a previous pairing operation with the transmitting device or via any other suitable techniques. The encryption module 1210 generates an encryption key, a GSK, for use in decrypting the broadcast isochronous data based on the GLTK and the GSKD obtained from the synchronization module 1204.

The packet exchange module 1214 is configured to receive and perform the initial processing of packets such as Bluetooth packets or Wi-Fi packets. For example, the packet exchange module 1214 may be configured to receive advertising packets and data packets including isochronous packets. For example, the packet exchange module 1214 may receive periodic advertising packets that include synchronization information or authentication information and provide the synchronization or authentication information to the synchronization module 1204 and the authentication module 1206, respectively. The packet exchange module 1214 also is configured to receive data packets, such as broadcast isochronous data packets, and to provide encrypted data to the encryption module 1210 or unencrypted data directly to the packaging module 1208.

One or both of the packet exchange module 1214 or the packaging module 1208 is further configured to extract or otherwise obtain reference information corresponding to and included with the data. The reference information can then be passed to the authentication module 1206 so that the authentication module can then compare the reference (timing) information received with the data to reference (timing) information in the certified nonce to authenticate the transmitting device as the true transmitting device from which the authentication data was received.

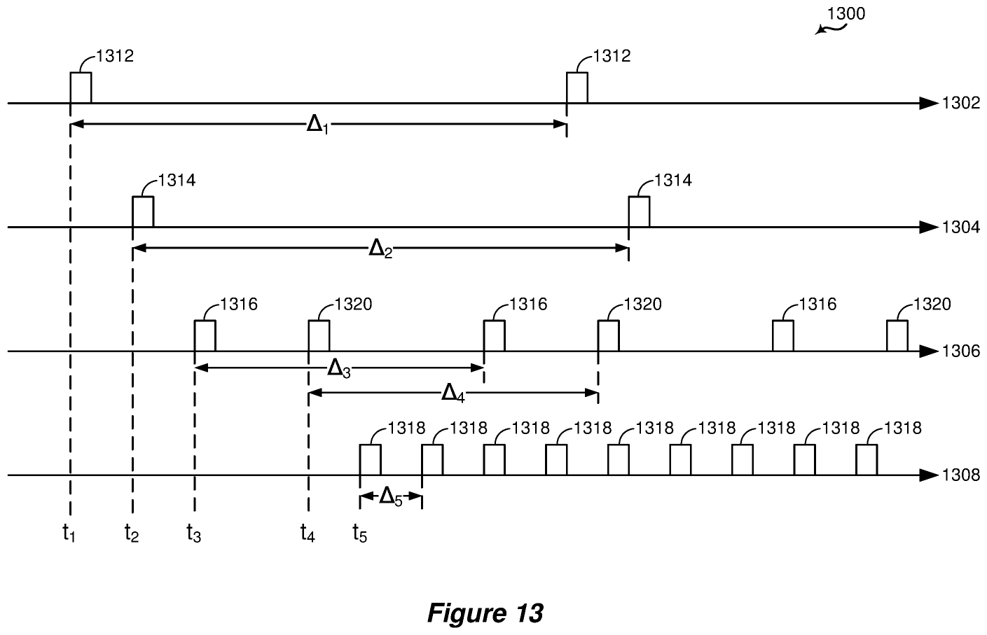

FIG. 13 shows a timing diagram 1300 illustrating a broadcast isochronous channel and a plurality of advertising channels capable of use by a wireless communication device such as the wireless communication devices 1100 or 1200 described with reference to FIGS. 11 and 12, respectively. In the illustrated implementation, the timing diagram 1300 includes a primary advertising channel 1302, a secondary advertising channel 1304 and a periodic advertising channel 1306, in addition to the isochronous channel 1308 via which the broadcast isochronous data packets are transmitted. The broadcasting device broadcasts extending advertising packets 1312 via the primary advertising channel 1302. For example, each of the extended advertising packets 1312 may be an ADV_EXT_IND packet in conformance with the Bluetooth 5.0 Specification. As shown, the broadcasting device broadcasts an extended advertising packet 1312 at time t₁. The broadcasting device may broadcast subsequent extending advertising packets 1312 at regular intervals Δ₁, for example, every second.

Each of these extending advertising packets 1312 includes synchronization information enabling scanning devices to identify, lock onto or otherwise synchronize with the secondary advertising channel 1304 to acquire other extended advertising packets 1314 that the broadcasting device broadcasts via the secondary advertising channel 1304. For example, each of the extended advertising packets 1314 may be an AUX_ADV_IND packet in conformance with the Bluetooth 5.0 Specification. As shown, the broadcasting device broadcasts an extended advertising packet 1314 at time t₂. The broadcasting device may broadcast subsequent extending advertising packets 1314 at regular intervals Δ₂, for example, every second.

Each of these other extending advertising packets 1314 includes synchronization information enabling scanning devices to identify, lock onto or otherwise synchronize with the periodic advertising channel 1306 to acquire periodic advertising packets 1316 that the broadcasting device broadcasts via the periodic advertising channel 1306. For example, each of the periodic advertising packets 1316 may be an AUX_SYNC_IND packet in conformance with the Bluetooth 5.0 Specification. As shown, the broadcasting device broadcasts a periodic advertising packet 1316 at time t₃. The broadcasting device may broadcast subsequent periodic advertising packets 1316 at regular intervals Δ₃, for example, one the order of every second or less. Each of periodic advertising packets 1316 includes synchronization information enabling receiving devices to identify, lock onto or otherwise synchronize with the isochronous channel 1308 to acquire the broadcast isochronous data packets 1318 of the BIS that the broadcasting device broadcasts via the isochronous channel 1308. As shown, the broadcasting device broadcasts an isochronous data packet 1318 at time tₛ. The broadcasting device 404 may broadcast the isochronous data packets 1318 at regular intervals Δ₅, for example, on the order of every second or less.

The synchronization information in the periodic advertising packets 1316 may include a GIV and a GSKD for a BIG. In some implementations, some or all of the same periodic advertising packets 1316 that contain the synchronization information also include authentication information. As described above, the authentication information may include a digital signature of the broadcasting device. For example, the broadcasting device can include the nonce, at least a portion of the synchronization information (such as a concatenation of the GSKD and the GIV), and the digital signature in a BIG synchronization information field within each of some or all of the periodic advertising packets 1316. Additionally or alternatively, the broadcasting device may broadcast the authentication information to the BIG in other advertising packets 1320. As shown, the broadcasting device broadcasts a periodic advertising packet 1320 that includes authentication data at time t₄. The broadcasting device 404 may broadcast the periodic advertising packets 1320 at regular intervals Δ₄, for example, on the order of every second or less. For example, each of the advertising packets 1320 can include a first field including opcode, a second field including timing information, a third field including at least a portion of the synchronization information (such as a concatenation of the GSKD and the GIV), and a fourth field including the digital signature. The opcode may indicate to the receiving devices that the periodic advertising packet 1320 includes authentication information.

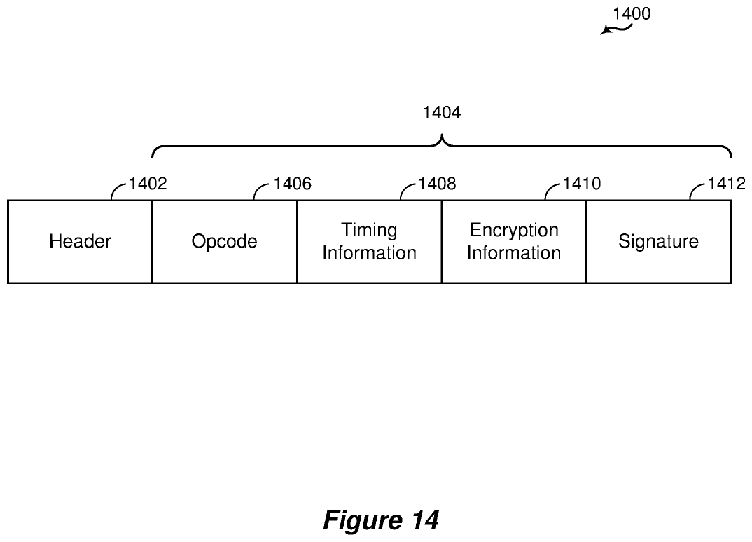

FIG. 14 shows an example protocol data unit (PDU) 1400 usable for conveying authentication information according to some implementations. For example, the PDU 1400 may be used by the transmitting device to transmit the authentication information to the wireless network in block 708 of the process 700 described with reference to FIG. 7. The PDU 1400 also may be an example of an advertising packet including the authentication information received by the receiving device in block 904 of the process 900 described with reference to FIG. 9. The PDU 1400 includes a header 1402 and a data field 1404 that includes authentication information. In some implementations, the data field 1404 itself includes a number of fields (or “sub-fields”) including, for example, a timing field 1406, an encryption field 1408 and a signature field 1410. The timing field 1406 may include a timestamp, for example, identifying the current date and time, and in some instances, the current time zone. The encryption field 1408 can include encryption information, for example, at least a portion of the synchronization information (such as a concatenation of the GIV and the GSKD for a BIG). The signature field 1410 includes a digital signature of the transmitting device, such as that transmitted or received in any of the processes 700, 800, 900 or 1000 described above with reference to FIGS. 7, 8, 9 and 10, respectively. The PDU 1400 also can include an opcode field 1412 that includes an authentication indicator indicating that the subsequent data in the data field 1402 is authentication information. In some implementations, each of the timing field 1406, the encryption field 1408 and the signature field 1410 is encrypted using an encryption key (such as a GSK). In some such implementations, the opcode field 1412 is not encrypted using the encrypted key.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b but not c, a combination of a and c but not b, a combination of b and c but not a, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication by a transmitting device, comprising:
obtaining a public and private key pair for wireless communications with a wireless network that includes at least one receiving device;
transmitting synchronization information for the wireless communications to the wireless network;
generating a digital signature using the private key based on a nonce and at least a portion of the synchronization information; and
transmitting authentication information to the wireless network, the authentication information including the digital signature.

2. The method of claim 1, wherein the wireless communications are broadcast isochronous communications, the method further including:
generating an encryption key for the broadcast isochronous communications;
encrypting isochronous data using the encryption key; and
broadcasting the encrypted isochronous data to the wireless network in at least one isochronous data packet.

3. The method of claim 2, further including encrypting the authentication information using the encryption key, wherein the transmitted authentication information is the encrypted authentication information.

4. The method of claim 3, wherein generating the encryption key includes:
generating a Group Long Term Key (GLTK);
generating a Group Session Key Diversifier (GSKD); and
generating a Group Session Key (GSK) based on the GLTK and the GSKD.

5. The method of claim 4, further including generating a Group Initialization Vector (GIV), wherein the synchronization information includes the GSKD and the GIV.

6. The method of claim 5, wherein generating the digital signature includes executing a digital signature algorithm that certifies the nonce and a combination of the GSKD and the GIV using the private key.

7. The method of claim 1, wherein the nonce includes a timestamp or a counter.

8. The method of claim 1, wherein transmitting the synchronization information to the wireless network includes broadcasting the synchronization information in at least one first advertising packet.

9. The method of claim 8, wherein transmitting the authentication information to the wireless network includes broadcasting the authentication information in the at least one first advertising packet.

10. A wireless communication device comprising:
at least one processor; and
at least one memory communicatively coupled with the at least one processor and storing processor-readable code that, when executed by the at least one processor, causes the wireless communication device to:
obtain a public and private key pair for wireless communications with a wireless network that includes at least one receiving device;
transmit synchronization information for the wireless communications to the wireless network;
generate a digital signature using the private key based on a nonce and at least a portion of the synchronization information; and
transmit authentication information to the wireless network, the authentication information including the digital signature.

11. The wireless communication device of claim 10, wherein the wireless communications are broadcast isochronous communications, the code further being configured to, when executed by the at least one processor, cause the wireless communication device to:
generate an encryption key for the broadcast isochronous communications;
encrypt isochronous data using the encryption key; and
broadcast the encrypted isochronous data to the wireless network in at least one isochronous data packet.

12. The wireless communication device of claim 11, wherein the code is further configured to, when executed by the at least one processor, cause the wireless communication device to encrypt the authentication information using the encryption key, wherein the transmitted authentication information is the encrypted authentication information.

13. The wireless communication device of claim 12, wherein to generate the encryption key, the code is configured to, when executed by the at least one processor, cause the wireless communication device to:
generate a Group Long Term Key (GLTK);
generate a Group Session Key Diversifier (GSKD); and
generate a Group Session Key (GSK) based on the GLTK and the GSKD.

14. The wireless communication device of claim 13, wherein the code is further configured to, when executed by the at least one processor, cause the wireless communication device to generate a Group Initialization Vector (GIV), wherein the synchronization information includes the GSKD and the GIV.

15. The wireless communication device of claim 14, wherein to generate the digital signature, the code is configured to, when executed by the at least one processor, cause the wireless communication device to execute a digital signature algorithm that certifies the nonce and a combination of the GSKD and the GIV using the private key.

16. The wireless communication device of claim 10, wherein the nonce includes a timestamp or a counter.

17. A method for wireless communication by a receiving device, comprising:
obtaining a public key for wireless communications;
receiving, from a transmitting device, synchronization information for the wireless communications;
receiving, from the transmitting device, authentication information for the wireless communications, the authentication information including a digital signature of the transmitting device, the digital signature being based on a nonce and a combination of at least a portion of the synchronization information;
verifying the digital signature using the public key;
receiving, based on at least a portion the synchronization information, at least one data packet including data and reference information; and
authenticating, based on the verified digital signature and the reference information, the received data.

18. The method of claim 17, wherein the wireless communications are broadcast isochronous communications and wherein the received data is encrypted, the method further including:
generating an encryption key for the wireless communications; and
decrypting the received broadcast isochronous data using the encryption key.

19. The method of claim 18, wherein the received authentication information is encrypted, the method further including decrypting the received authentication information using the encryption key.

20. The method of claim 19, wherein the synchronization information includes a Group Session Key Diversifier (GSKD), the method further including:
obtaining a Group Long Term Key (GLTK); and
generating the encryption key based on the GLTK and the GSKD.

21. The method of claim 20, wherein the synchronization information includes the GSKD and a Group Initialization Vector (GIV), and wherein the combination of the synchronization information includes the GSKD and the GIV.

22. The method of claim 21, wherein verifying the digital signature includes executing a digital signature algorithm that, using the public key, indicates that the nonce and the combination of the synchronization information have been certified by the transmitting device using a private key of the transmitting device.

23. The method of claim 22, wherein the reference information includes timing information, and wherein authenticating the received data comprises:
identifying timing information in the nonce;
comparing the timing information in the reference information with the timing information identified in the nonce; and
authenticating the received data based on the comparison.

24. The method of claim 23, wherein the timing information in the nonce includes a timestamp or a counter.

25. A wireless communication device comprising:
at least one processor; and
at least one memory communicatively coupled with the at least one processor and storing processor-readable code that, when executed by the at least one processor, causes the wireless communication device to:
obtain a public key for wireless communications;
receive, from a transmitting device, synchronization information for the wireless communications;
receive, from the transmitting device, authentication information for the wireless communications, the authentication information including a digital signature of the transmitting device, the digital signature being based on a nonce and a combination of at least a portion of the synchronization information;
verify the digital signature using the public key;
receive, based on at least a portion the synchronization information, at least one data packet including data and reference information; and
authenticate, based on the verified digital signature and the reference information, the received data.

26. The wireless communication device of claim 25, wherein the wireless communications are broadcast isochronous communications and wherein the received data is encrypted, the code being further configured to, when executed by the at least one processor, cause the wireless communication device to:
generate an encryption key for the wireless communications; and
decrypt the received broadcast isochronous data using the encryption key.

27. The wireless communication device of claim 26, wherein the received authentication information is encrypted, the code being further configured to, when executed by the at least one processor, cause the wireless communication device to decrypt the received authentication information using the encryption key.

28. The wireless communication device of claim 27, wherein the synchronization information includes a Group Session Key Diversifier (GSKD), the code being further configured to, when executed by the at least one processor, cause the wireless communication device to:
obtain a Group Long Term Key (GLTK); and
generate the encryption key based on the GLTK and the GSKD.

29. The wireless communication device of claim 28, wherein the synchronization information includes the GSKD and a Group Initialization Vector (GIV), and wherein the combination of the synchronization information includes the GSKD and the GIV.

30. The wireless communication device of claim 29, wherein to verify the digital signature, the code is configured to, when executed by the at least one processor, cause the wireless communication device to execute a digital signature algorithm that, using the public key, indicates that the nonce and the combination of the synchronization information have been certified by the transmitting device using a private key of the transmitting device.

31. The wireless communication device of claim 30, wherein the reference information includes timing information, and wherein to authenticate the received data the code is configured to, when executed by the at least one processor, cause the wireless communication device to:
identify timing information in the nonce;
compare the timing information in the reference information with the timing information identified in the nonce; and
authenticate the received data based on the comparison.
